(19) United States
(12) Patent Application Publication
(10) Pub. No.: US 2014/0176887 A1
(43) Pub. Date: Jun. 26, 2014

(54) OPTICAL LAMINATE FILM, AND POLARIZER AND LIQUID CRYSTAL DISPLAY DEVICE USING THE FILM

(71) Applicant: FUJIFILM Corporation, Tokyo (JP)

(72) Inventors: Jun TAKEDA, Kanagawa (JP); Masato NAKAO, Kanagawa (JP)

(73) Assignee: FUJIFILM CORPORATION, Tokyo (JP)

(21) Appl. No.: 14/192,125

(22) Filed: Feb. 27, 2014

Related U.S. Application Data
(63) Continuation of application No. PCT/JP2012/071370, filed on Aug. 17, 2012.

(30) Foreign Application Priority Data
Aug. 30, 2011 (JP) 2011-186772

(51) Int. Cl. G02F 1/13363; G02B 5/30

(52) U.S. Cl. CPC G02F 1/133634; G02B 5/3083
USPC 349/118; 359/489.07

(57) ABSTRACT

An optical laminate film that comprises a layer B satisfying 1.0≦Nz≦3.0, 70 nm≦Re(550) and 0 nm≦Rth(550)≦200 nm, and a layer C satisfying Re(550)≦10 nm and −200 nm≦Rth(550)≦−50 nm, wherein the layer B and the layer C are adjacent to each other, the absolute value of the difference in SP between the main ingredient of the layer B and the main ingredient of the layer C is from 2.6 to 10.0, contribute toward improving the viewing angle characteristics of horizontal alignment mode liquid crystal display devices without causing problems of front contrast ratio reduction and display unevenness.

### CROSS-REFERENCE TO RELATED APPLICATIONS

This application is a continuation application of International Application No. PCT/JP2012/071370, filed Aug. 17, 2012, which in turn claims the benefit of priority from Japanese Application No. 2011-186772, filed Aug. 30, 2011, the disclosures of which applications are incorporated by reference herein in their entirety.

### BACKGROUND OF THE INVENTION

1. Field of the Invention

The present invention relates to an optical laminate film useful as an optical film for horizontal alignment mode liquid crystal display devices such as IPS-mode or FFS-mode devices, and to a polarizer and a liquid crystal display device using the film.

2. Background Art

It is known that a laminate of a negative biaxial film and a positive C-plate is useful for improving the viewing angle characteristics of horizontal alignment mode liquid crystal display devices such as IPS-mode devices, etc. (for example, Patent Reference 1). On the other hand, however, it is in fact difficult to integrate a negative biaxial film and a positive C-plate that are layers differing from each other in the optical characteristics, without detracting from the individual properties thereby to give a laminate film, and it may be said that the technique of stability producing such a laminate film is still in the process of developing.

One example of the positive C-plate is a homeotropic alignment liquid crystal layer, as disclosed in Patent Reference 1. The liquid crystal layer is generally formed by coating, in which, however, it is difficult to secure uniform homeotropic alignment of liquid crystal molecules, and heretofore, various proposals have been made for the controlling method for the molecules (for example, Patent Reference 2). However, when a laminate film having a homeotropic alignment liquid crystal layer is used in a liquid crystal display device, it may lower the contrast ratio or may cause display unevenness, and therefore solving the problems is desired.

The positive C-plate may be formed of a negative birefringent polymer material (for example, Patent Reference 3), however, even when the positive C-plate formed of a negative birefringent polymer material is used, it may also lower the contrast ratio or may cause display unevenness like the above, and therefore solving the problems is desired.
Patent Reference 1: U.S. Pat. No. 7,283,189
Patent Reference 2: JP-A 2002-333524
Patent Reference 3: JP-A 2009-168900

### SUMMARY OF THE INVENTION

As described above, when a conventional positive C-plate is used in an embodiment useful as an optical film for horizontal alignment mode liquid crystal display device, or that is, in an embodiment of a laminate film as laminated with a negative biaxial film, and when the resulting laminate film is actually used in liquid crystal display devices, then there occur various problems of front contrast ratio reduction and display unevenness, and solving the problems is desired.

The present invention is to solve the above-mentioned problems.

Concretely, an object of the invention is to provide an optical laminate film and a polarizer that contribute toward improving the viewing angle characteristics of horizontal alignment mode liquid crystal display devices not causing problems of front contrast ratio reduction and display unevenness.

Another object of the invention is to provide a horizontal alignment mode liquid crystal display device free from problems of front contrast ratio reduction and display unevenness and having good viewing angle characteristics.

The present inventors have variously investigated for the purpose of solving the above-mentioned problems and, as a result, have found that, when the absolute value of the SP difference (ΔSP) between the main ingredients of the positive C-plate and the negative biaxial film is large, then the above-mentioned problems can be solved. On the basis of this finding, the inventors have made further investigations and have completed the present invention. Problems of display unevenness generation and contrast ratio reduction are relevant to the internal haze of film, and therefore, for solving the problems, one would generally take an idea of not selecting the materials to cause haze increase, and for example, for laminate films, the main ingredients of the individual layers would be formed of materials having similar properties. As opposed to this, however, in the present invention, surprisingly and unpredictably, the laminate film in which the main ingredients of the individual constituent layers are so combined as to have a large ΔSP can solve the above-mentioned problems. One reason for the advantage of the present invention would be as follows: Since ΔSP of the main ingredients of the individual constituent layers in the laminate film is large, the ingredients would not mix together but could independently keep good planarity in the interlayer boundary of the constituent layers, not providing any interface irregular, and as a result, the laminate film could hardly generate depolarization and therefore could solve the problems of display unevenness generation and contrast ratio reduction.

Concretely, the means for solving the above-mentioned problems are as follows:

[1] An optical laminate film that comprises a layer B satisfying the following three formulae (Ib) to (IIIb):

1.0≦Nz≦3.0 (Ib):

70 nm≦Re(550) (IIb):

0 nm≦Rth(550)≦200 nm, (IIIb):

and a layer C satisfying the following two formulae (Ic) and (IIc):

Re(550)≦10 nm (Ic):

−200 nm≦Rth(550)≦−50 nm, (IIc):

wherein the layer B and the layer C are adjacent to each other, the absolute value of the difference in SP, as calculated on the basis of the Hoy method, between the main ingredient of the layer B and the main ingredient of the layer C, |ΔSP| is from 2.6 to 10.0.
[2] The optical laminate film of [1], wherein the main ingredient of the layer B is a cellulose acetate having a degree of substitution of from 2.0 to 2.8.
[3] The optical laminate film of [1] or [2], wherein the main ingredient of the layer B is a cellulose acetate having a degree of substitution of from 2.2 to 2.5.
[4] The optical laminate film of any one of [1] to [3], wherein the photoelastic coefficient of the layer B is at most 40.
[5] The optical laminate film of any one of [1] to [4], wherein the layer C is a layer comprising a polymer organic compound as the main ingredient thereof.
[6] The optical laminate film of any one of [1] to [4], wherein the layer C is a layer formed by fixing the homeotropic alignment of a composition that comprises rod-shaped liquid crystal molecules as the main ingredient thereof.
[7] The optical laminate film of any one of [1] to [6], wherein at least one of the layer C and the layer B is a layer formed by coating.
[8] The optical laminate film of any one of [1] to [7], having a total thickness of at most 80 μm.
[9] A polarizer comprising a polarizing element and the optical laminate film of any one of [1] to [8].
[10] A horizontal alignment mode liquid crystal display device having the optical laminate film of any one of [1] to [8].

According to the invention, there are provided an optical laminate film and a polarizer that contribute toward improving the viewing angle characteristics of horizontal alignment mode liquid crystal display devices not causing problems of front contrast ratio reduction and display unevenness.

According to the invention, there is also provided a horizontal alignment mode liquid crystal display device free from problems of front contrast ratio reduction and display unevenness and having good viewing angle characteristics.

### BRIEF DESCRIPTION OF THE DRAWINGS

FIG. 1 is a schematic cross-sectional view showing one example of the polarizer of the invention.

FIG. 2 is a schematic cross-sectional view showing another example of the polarizer of the invention.

FIG. 3 is a schematic cross-sectional view showing one example of the liquid crystal display device of the invention.

FIG. 4 is a schematic cross-sectional view showing one example of the liquid crystal display device of the invention.

### MODE FOR CARRYING OUT THE INVENTION

The invention is described in detail hereinunder. In this description, the numerical range expressed by the wording “a number to another number” means the range that falls between the former number indicating the lower limit of the range and the latter number indicating the upper limit thereof.

In this description, Re(λ) and Rth(λ) each mean the in-plane retardation and the thickness-direction retardation, respectively, of a film at a wavelength of λ. Unless otherwise specifically indicated in this description, the wavelength λ is 590 nm. Re(λ) is measured by applying a light having a wavelength of λ nm to a film sample in the normal direction of the film, using KOBRA 21ADH or WR (by Oji Scientific Instruments). In selecting the measuring wavelength λ nm, the wavelength selection filter may be changed manually, or the measured values may be converted by a program or the like.

In case where the film to be analyzed is one capable of being expressed by a monoaxial or biaxial index ellipsoid, Rth(λ) may be calculated according to the method mentioned below.

With the in-plane slow axis (determined by KOBRA 21ADH or WR) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above, when the film has a direction in which the retardation thereof is zero at a certain tilt angle relative to the in-plane slow axis thereof in the normal direction taken as a rotation axis, the sign of the retardation value of the film at the tilt angle larger than that tilt angle is changed to negative prior to computation with KOBRA 21ADH or WR.

Apart from this, Re(λ) may also be measured as follows: With the slow axis taken as the tilt axis (rotation axis) of the film (in case where the film has no slow axis, the rotation axis of the film may be in any in-plane direction of the film), the retardation is measured in any desired two directions, and based on the thus-determined retardation data, the assumptive mean refractive index and the inputted film thickness, Rth is computed according to the following formulae (1) and (2).

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( 1 ) \\ Rth = \{ ( nx + ny ) / 2 - nz \} \times d & ( 2 )\end{matrix}$$

In the above formulae, Re(θ) means the retardation of the film in the direction tilted by an angle θ from the normal direction to the film; nx means the in-plane refractive index of the film in the slow axis direction; ny means the in-plane refractive index of the film in the direction perpendicular to nx; nz means the refractive index in the direction perpendicular to nx and ny; and d means the film thickness.

In case where the film to be analyzed is not expressed as a monoaxial or biaxial index ellipsoid, or that is, when the film does not have an optical axis, Rth(λ) thereof may be computed as follows:

With the in-plane slow axis (determined by KOBRA 21ADH or WR) taken as the tilt axis (rotation axis) of the film, Re(λ) of the film is measured at 11 points in all thereof, in a range of from −50 degrees to +50 degrees relative to the film normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above measurement, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below. Cellulose acylate (1.48), cycloolefin polymer (1.52), polycarbonate (1.59), polymethyl methacrylate (1.49), polystyrene (1.59). With the assumptive mean refractive index and the film thickness inputted thereinto, KOBRA 21ADH or WR can compute nx, ny and nz. From the thus-computed data nx, ny and nz, Nz=(nx−nz)/(nx−ny) is computed.

Unless otherwise specifically indicated in this description, the measuring wavelength for the refractive index is 550 nm.

### 1. Optical Laminate Film

The invention relates to an optical laminate film that comprises a layer B satisfying the following three formulae (Ib) to (IIIb):

1.0≦Nz≦3.0 (Ib):

70 nm≦Re(550) (IIb):

0 nm≦Rth(550)≦200 nm, (IIIb):

and a layer C satisfying the following two formulae (Ic) and (IIc):

Re(550)≦10 nm (Ic):

−200 nm≦Rth(550)≦−50 nm, (IIc):

wherein the absolute value of the SP difference between the main ingredients of the layer B and the layer C, |ΔSP| is from 2.6 to 10.0.

The layer B satisfies the above formulae (Ib) to (IIIb), and is a so-called negative biaxial layer; while the layer C satisfies the above formulae (Ic) and (IIc), and is a so-called positive C-plate. The optical laminate film of the invention exhibits optical characteristics that contribute toward improving the viewing angle characteristics of a horizontal alignment mode liquid crystal display device. Heretofore, when an optical laminate film having the same configuration as herein has been actually used in a horizontal alignment mode liquid crystal display device, then there have occurred problems of display unevenness generation and front contrast ratio reduction. Contrary to this, however, in the optical laminate film of the invention, |ΔSP| of the main ingredients of the individual constituent layer B and layer C falls within the above range, and therefore, the main ingredients of the two layers do not mix together and the two layers can independently keep good surface planarity. Consequently, in the optical laminate film of the invention, there hardly occurs any interface irregular, and as a result, the laminate film is free from the problems of display unevenness and contrast ratio reduction to be caused by that phenomenon, or that is, the constituent layers in the film individually contribute toward improving the viewing angle characteristics of the devices comprising the film owing to the individual optical properties that the layers have.

For attaining the above-mentioned effect, the absolute value of the SP difference between the main ingredients of the layer B and the layer C, |ΔSP| is at least 2.6. Preferably, |ΔSP| is at least 2.65, more preferably at least 2.7, even more preferably at least 3. The effect could be higher when |ΔSP| is larger; however, when |ΔSP| is too large, then the interlayer adhesiveness between the layer B and the layer C would worsen. Therefore, |ΔSP| is at most 10 and is preferably at most 9, more preferably at most 8.

So far as |ΔSP| falls within the above range, the SP values of the main ingredients of the layer B and the layer C are not specifically defined, and the magnitude relationship between the SP value of the main ingredient of the layer B and that of the main ingredient of the layer C is not also specifically defined. In general, the SP values of the main ingredients of the layer B and the layer C each are from 17 to 27 or so.

In this description, the SP value means the solubility parameter value as calculated according to the Hoy method. The Hoy method is described in Polymer Handbook, 4th Edition. |ΔSP| means the absolute value of the difference in the SP value, of the main ingredients of the layer B and the layer C(SPb and SPc), as calculated on the basis of the Hoy method, |SPb−SPc|.

Not specifically defined, the main ingredients of the layer B and the layer C may be any ones which can form the layers that satisfy the above-mentioned optical characteristics and which are so combined that |ΔSP| can fall within the above-mentioned range. The materials may be non-liquid crystalline materials or liquid crystalline materials. In order that both the layer B and the layer C can be tough layers enough to be self-sustainable in some degree, the main ingredients of the layers are preferably polymer organic compounds. In this description, the term “polymer organic compound” includes any of resin or polymerized and cured product of polymerizing composition. Needless-to-say, for example, the layer may be one formed by curing a curable composition that contains a low-molecular-weight material as the main ingredient thereof. The main ingredient of the cured layer formed by curing a curable composition that contains a low-molecular-weight material as the main ingredient thereof is the polymer of the low-molecular-weight material contained in the cured layer.

The problem of interface irregular often occurs especially when at least one of the layer B and the layer C is a layer formed by coating; and therefore, the invention is especially effective in the embodiment where at least one of the layer B and the layer C is formed by coating. The invention is also effective in an embodiment where at least one of the layer B and the layer C is a layer to be formed by coating and the other is a polymer film to support the layer. However, the invention is not limited to these embodiments.

It may be considered that the reason of display unevenness generation and contrast ratio reduction would be not only because of the interface irregular between the constituent layers but also because of the load to be actually applied when the optical film is mounted on a liquid crystal panel. In particular, Re of the layer B is large and therefore it is considered that the load to be applied to the layer in mounting the film on a device would cause display unevenness generation. For solving the problem, it is desirable to lower the photoelastic coefficient of the layer B, and concretely, the photoelastic coefficient of the layer B is preferably at most 40, more preferably at most 30. From the viewpoint of preventing the generation of display unevenness, the photoelastic coefficient of the layer B is preferably lower; however, the lower limit of the photoelastic coefficient of existing materials would be 1 or so. Examples of the film having a photoelastic coefficient of at most 40 include films of cellulose acylate to be mentioned below (for example, cellulose acetate has a photoelastic coefficient of 20 or so), cyclic olefin films, and films mainly comprising polymethyl methacrylate, etc. On the other hand, examples of the film having a photoelastic coefficient of more than 40 include films mainly comprising a polycarbonate resin.

In this description, the “photoelastic coefficient” means an average of the photoelastic coefficient values in the directions perpendicular to each other. With reference to a film produced continuously taken here as an example, the photoelastic coefficient of the film is an average of the photoelastic coefficient values in the machine direction (MD) of the film and the transverse direction (TD) thereof perpendicular to the machine direction.

Materials suitable for the main ingredients of the layer B and the layer C satisfying the above-mentioned optical characteristics are described below. “Main ingredient” as referred to herein means the ingredient that is contained in the layer at a highest ratio therein.

### Layer B:

The layer B is a so-called negative biaxial layer satisfying the following three formulae:

1.0≦Nz≦3.0 (Ib):

70 nm≦Re(550) (IIb):

0 nm≦Rth(550)≦200 nm (IIIb):

From the viewpoint of the effect of improving the viewing angle characteristics of horizontal alignment mode liquid crystal display devices, the layer B preferably satisfies the following three formulae:

1.05≦Nz≦2.5 (Ib′):

70 nm≦Re(550)≦170 nm (IIb′):

20 nm≦Rth(550)≦150 nm, (IIIb′):

more preferably the following three formulae:

1.1≦Nz≦2.0 (Ib″):

80 nm≦Re(550)≦150 nm (IIb″):

30 nm≦Rth(550)≦120 nm (IIIb″):

Examples of the materials capable of forming the layer that satisfies the above-mentioned optical characteristics include cellulose acylate, cyclic olefin resin, polyethylene terephthalate resin, polycarbonate resin, polymethyl methacrylate resin. One example of the layer B is a film containing cellulose acylate as the main ingredient thereof (hereinafter this may be referred to as “cellulose acylate film”). As described above, the cellulose acylate film is preferred here, for example, as compared with a film containing polycarbonate or the like as the main ingredient thereof, since the photoelastic coefficient of the cellulose acylate film is small and since the film can reduce more the generation of display unevenness to be caused by the load applied in mounting the film on a liquid crystal panel.

The starting cellulose for the cellulose acylate for use in the invention includes cotton linter and wood pulp (hardwood pulp, softwood pulp), etc.; and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8. Cellulose materials described in these may be used here.

The β-1,4-bonding glucose unit to constitute cellulose has a free hydroxyl group at the 2-, 3- and 6-positions. The cellulose acylate is a polymer produced by esterifying a part or all of those hydroxyl groups in cellulose with an acyl group having at least 2 carbon atoms. The degree of acyl substitution means the total of the ratio of acylation of the hydroxyl group in cellulose positioned in the 2-, 3- and 6-positions in the unit therein. In case where the hydroxyl group is 100% esterified at each position, the degree of substitution at that position is 1. Accordingly, the total degree of acyl substitution DS2+DS3+DS6 (DS2, DS3 and DS6 each mean the degree of acyl substitution at the 2-, 3- and 6-positioned hydroxyl groups, respectively) is at most 3. The degree of acyl substitution of the cellulose acylate usable as the layer B is not specifically defined. From the viewpoint of the film formability, the total degree of acyl substitution is preferably at most 2.8, more preferably from 2.0 to 2.8. In general, when the total degree of acyl substitution is lower, then the SP value of the polymer is higher, and therefore, |ΔSP| can vary within a large range relative to the SP value of various materials for use as the main ingredient of the layer C; and from this viewpoint, preferred here is use of a cellulose acylate having a low degree of substitution, and more preferred is use of a cellulose acylate having a total degree of acyl substitution of at most 2.5 (more preferably at most 2.48, even more preferably at most 2.46). On the other hand, however, when the total degree of substitution of cellulose acylate for use herein is too low, then it is unfavorable from the viewpoint of the film formability and the moisture absorption of the film. Comprehensively from these viewpoints, preferred for use herein is a cellulose acylate having a total degree of acyl substitution of from 2.2 to 2.5 (more preferably from 2.3 to 2.46). A cellulose acylate having a low degree of acyl substitution is preferred here as excellent in expressibility of the optical characteristics of the film thereof, and another advantage thereof is that the cellulose acylate of the type can form a thinner layer B capable of securing the above-mentioned optical characteristics.

The acyl group that the cellulose acylate has is a substituent represented by R—C(═O)—. R may be any of an alkyl group and an aryl group, or may also be an aralkyl group comprising a combination of the former two. Examples of the alkyl group for R include a C₁₋₁₅ linear, branched or cyclic alkyl group. Examples of the acyl group where R is an alkyl group include a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, and an oleoyl group. In case where the cellulose acylate has two or more different types of acyl groups, preferably, one of them is an acetyl group. Examples of the acyl group where R is an aryl group or an aralkyl group include a benzoyl group, a naphthylcarbonyl group, and a cinnamoyl group. Above all, preferred is an acyl group having a C₁₋₄ alkyl group, more preferred is an acetyl group, a propionyl group or a butanoyl group, and even more preferred is an acetyl group.

In case where an acid anhydride or an acid chloride is used as the acylating agent for acylation of cellulose, the organic solvent as the reaction solvent includes organic acids such as acetic acid, methylene chloride, etc. In case where the acylating agent is an acid anhydride, the catalyst is preferably a protic catalyst such as sulfuric acid; and in case where the acylating agent is an acid chloride (e.g., CH₃CH₂COCl), then a basic compound may be used as the catalyst.

One example of industrial-scale production of a mixed fatty acid ester of cellulose is a method of acylating cellulose with a mixed organic acid component that contains a fatty acid corresponding to an acetyl group or any other acyl group (acetic acid, propionic acid, valeric acid, etc.) or an acid anhydride thereof. The cellulose acylate for use in the invention may be produced, for example, according to the method described in JP-A 10-45804.

Preferably, the layer B contains a cellulose acylate as the main ingredient thereof. In the layer B, preferably, the cellulose acylate is contained in an amount of at least 70% by mass, more preferably at least 80% by mass, or may be contained in an amount of 100% by mass. However, in an embodiment where one or more additives are added to the layer for the purpose of expressing optical characteristics, the content of the cellulose acylate in the layer is preferably at most 96% by mass, more preferably at most 98% by mass.

The layer B may contain any other additive than the main ingredient therein. The additive may be added to the layer for the purpose of enhancing, reducing or controlling the optical characteristics, and in addition, may also be added thereto for the purpose of improving the mechanical properties and the film formability of the layer.

One example of the additive to the cellulose acylate film is a high-molecular-weight additive having a number-average molecular weight of from 700 to 10000. The high-molecular-weight additive is used for the purpose of promoting the evaporation speed of solvent or for reducing the residual solvent amount in the layer in a solution casting method. Also in the film to be produced according to a melt casting method, the high-molecular-weight additive is useful as a material for preventing film discoloration or for preventing film strength reduction. Further, from the viewpoint of film property modification for improving the mechanical characteristics, for imparting flexibility to film, for imparting water absorption resistance thereto and for reducing the moisture permeability of film, the high-molecular-weight additive is effective. Further, the high-molecular-weight additive may also serve as an Rth reducer.

The number-average molecular weight of the high-molecular-weight additive is more preferably from 700 to less than 10000, even more preferably from 800 to 8000, still more preferably from 800 to 5000, and especially preferably, the number-average molecular weight thereof is from 1000 to 5000. Having the molecular weight falling within the range, the additive is more excellent in miscibility with cellulose acylate. In particular, the content of the high-molecular-weight additive is preferably from 4 to 30% by mass of cellulose acylate, more preferably from 10 to 25% by mass.

Examples of the high-molecular-weight additive include polyester polymer, styrenic polymer, acrylic polymer and their copolymer. Preferred are aliphatic polyester and aromatic polyester.

### Polyester Polymer

The polyester polymer usable as the additive to the layer B is one to be obtained through reaction of a mixture of an aliphatic dicarboxylic acid having from 2 to 20 carbon atoms and an aromatic dicarboxylic acid having from 8 to 20 carbon atoms, and at least one diol selected from an aliphatic diol having from 2 to 12 carbon atoms, an alkyl ether diol having from 4 to 20 carbon atoms and an aromatic diol having from 6 to 20 carbon atoms, and both terminals of the reaction product could be as they are in the reaction product, but may be capped through further reaction with a monocarboxylic acid, a monoalcohol or phenol. Effectively, the terminal capping is attained especially in order that the polymer does not contain any free carboxylic acid from the viewpoint of the storability thereof. The dicarboxylic acid to be used for the polyester polymer is preferably for an aliphatic dicarboxylic acid residue having from 4 to 20 carbon atoms or an aromatic dicarboxylic acid residue having from 8 to 20 carbon atoms.

The aliphatic dicarboxylic acid having from 2 to 20 carbon atoms includes, for example, oxalic acid, malonic acid, succinic acid, maleic acid, fumaric acid, glutaric acid, adipic acid, pimelic acid, suberic acid, azelaic acid, sebacic acid, dodecanedicarboxylic acid and 1,4-cyclohexanedicarboxylic acid. The aromatic dicarboxylic acid having from 8 to 20 carbon atoms includes phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, 2,6-naphthalenedicarboxylic acid, etc.

Of those, preferred aliphatic dicarboxylic acids are malonic acid, succinic acid, maleic acid, fumaric acid, glutaric acid, adipic acid, azelaic acid, 1,4-cyclohexanedicarboxylic acid; and preferred aromatic dicarboxylic acids are phthalic acid, terephthalic acid, isophthalic acid, 1,5-naphthalenedicarboxylic acid, 1,4-naphthalenedicarboxylic acid. More preferred aliphatic dicarboxylic acids are succinic acid, glutaric acid and adipic acid; and more preferred aromatic dicarboxylic acids are phthalic acid, terephthalic acid and isophthalic acid.

In the invention, of those mentioned above, at least one aliphatic dicarboxylic acid and at least one aromatic dicarboxylic acid are combined, and the combination thereof is not specifically defined. If desired, different types of the individual components may be combined in any desired manner with no problem.

The diol or the aromatic ring-containing diol to be used for the high-molecular-weight additive is selected from, for example, aliphatic diols having from 2 to 20 carbon atoms, alkyl ether diols having from 4 to 20 carbon atoms, and aromatic ring-containing diols having from 6 to 20 carbon atoms.

The aliphatic diol having from 2 to 20 carbon atoms includes alkyldiols and alicyclic diols. For example, there are mentioned ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, etc. One alone or two or more different types of these glycols may be used here either singly or as combined as a mixture thereof.

Preferred aliphatic diols for the invention are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, 1,4-cyclohexanedimethanol; and more preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, 1,4-cyclohexanedimethanol.

The alkyl ether diol having from 4 to 20 carbon atoms is preferably polytetramethylene ether glycol, polyethylene ether glycol, polypropylene ether glycol and their combination. Not specifically defined, the mean degree of polymerization of the diol is preferably from 2 to 20, more preferably from 2 to 10, even more preferably from 2 to 5, still more preferably from 2 to 4. As examples of the diol, there are mentioned typically useful, commercially-available polyether glycols, Carbowax Resin, Pluronics Resin and Niax Resin.

Not specifically defined, the aromatic diol having from 6 to 20 carbon atoms include bisphenol A, 1,2-hydroxybenzene, 1,3-hydroxybenzene, 1,4-hydroxybenzene, 1,4-benzenedimethanol. Preferred are bisphenol A, 1,4-hydroxybenzene and 1,4-benzenedimethanol.

Preferably, the high-molecular-weight additive for use in the invention is one terminal-capped with an alkyl group or an aromatic group. This is because terminal capping with a hydrophobic functional group is effective for enhancing the aging resistance of the compound in high-temperature high-humidity environments, and the terminal capping group could act to retard the hydrolysis of the ester group.

Preferably, both terminals of the polyester additive for use in the invention are protected with a monoalcohol residue or a monocarboxylic acid residue so as not to be a carboxylic acid group or an OH group.

In this case, the monoalcohol is preferably a substituted or unsubstituted monoalcohol having from 1 to 30 carbon atoms, including aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol, etc.; and substituted alcohols such as benzyl alcohol, 3-phenylpropanol, etc.

Terminal capping alcohols preferred for use in the invention are methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol; and more preferred are methanol, ethanol, propanol, isobutanol, cyclohexyl alcohol, 2-ethylhexyl alcohol, isononyl alcohol, benzyl alcohol.

In case where the additive is terminal-capped with a monocarboxylic acid residue, the monocarboxylic acid for the monocarboxylic acid residue is preferably a substituted or unsubstituted monocarboxylic acid having from 1 to 30 carbon atoms. The monocarboxylic acid may be an aliphatic monocarboxylic acid or an aromatic ring-containing monocarboxylic acid. As preferred aliphatic monocarboxylic acids for use herein, there are mentioned acetic acid, propionic acid, butanoic acid, caprylic acid, caproic acid, decanoic acid, dodecanoic acid, stearic acid, oleic acid; and preferred aromatic ring-containing monocarboxylic acids are, for example, benzoic acid, p-tert-butylbenzoic acid, p-tert-amylbenzoic acid, orthotoluic acid, metatoluic acid, paratoluic acid, dimethylbenzoic acid, ethylbenzoic acid, normal-propylbenzoic acid, aminobenzoic acid, acetoxybenzoic acid, etc. One or more of these may be used here.

The high-molecular-weight additive as mentioned above for the invention can be produced according to an ordinary method. For example, the additive can be produced with ease according to a thermal melt condensation method of polyesterification or interesterification of the above-mentioned dicarboxylic acid and diol and/or the terminal capping monocarboxylic acid or monoalcohol; or according to an interfacial condensation method of an acid chloride of those acids and a glycol. The polyester additives are described in detail by Koichi Murai in “Additives, Theory and Application” (published by Miyuki Shobo Publishing, Mar. 1, 1973, 1st Printing of 1st Version). In addition, the materials described in JP-A 05-155809, JP-A 05-155810, JP-A 5-197073, JP-A 2006-259494, JP-A 07-330670, JP-A 2006-342227, and JP-A 2007-003679 are also usable here.

Specific examples of the polyester polymer usable in the invention are shown below. However, the polyester polymer for use in the invention is not limited to these.

TABLE 1

| | Dicarboxylic acid | | | Diol | | | |
|---|---|---|---|---|---|---|---|
| | Aromatic Dicarboxylic | Aliphatic Dicarboxylic | Dicarboxylic Acid Ratio | | Diol Ratio | | Number-Average |
| | Acid | Acid | (mol %) | Aliphatic Diol | (mol %) | Terminal Group | Molecular Weight |
| P-1 | — | AA | 100 | ethanediol | 100 | hydroxyl group | 1000 |
| P-2 | — | AA | 100 | ethanediol | 100 | hydroxyl group | 2000 |
| P-3 | — | AA | 100 | propanediol | 100 | hydroxyl group | 2000 |
| P-4 | — | AA | 100 | butanediol | 100 | hydroxyl group | 2000 |
| P-5 | — | AA | 100 | hexanediol | 100 | hydroxyl group | 2000 |
| P-6 | — | AA/SA | 60/40 | ethanediol | 100 | hydroxyl group | 900 |
| P-7 | — | AA/SA | 60/40 | ethanediol | 100 | hydroxyl group | 1500 |
| P-8 | — | AA/SA | 60/40 | ethanediol | 100 | hydroxyl group | 1800 |
| P-9 | — | SA | 100 | ethanediol | 100 | hydroxyl group | 1500 |
| P-10 | — | SA | 100 | ethanediol | 100 | hydroxyl group | 2300 |
| P-11 | — | SA | 100 | ethanediol | 100 | hydroxyl group | 6000 |
| P-12 | — | SA | 100 | ethanediol | 100 | hydroxyl group | 1000 |
| P-13 | PA | SA | 50/50 | ethanediol | 100 | hydroxyl group | 1000 |
| P-14 | PA | SA | 50/50 | ethanediol | 100 | hydroxyl group | 1800 |
| P-15 | PA | AA | 50/50 | ethanediol | 100 | hydroxyl group | 2300 |
| P-16 | PA | SA/AA | 40/30/30 | ethanediol | 100 | hydroxyl group | 1000 |
| P-17 | PA | SA/AA | 50/20/30 | ethanediol | 100 | hydroxyl group | 1500 |
| P-18 | PA | SA/AA | 50/30/20 | ethanediol | 100 | hydroxyl group | 2600 |
| P-19 | TPA | SA | 50/50 | ethanediol | 100 | hydroxyl group | 1000 |
| P-20 | TPA | SA | 50/50 | ethanediol | 100 | hydroxyl group | 1200 |
| P-21 | TPA | AA | 50/50 | ethanediol | 100 | hydroxyl group | 2100 |
| P-22 | TPA | SA/AA | 40/30/30 | ethanediol | 100 | hydroxyl group | 1000 |
| P-23 | TPA | SA/AA | 50/20/30 | ethanediol | 100 | hydroxyl group | 1500 |
| P-24 | TPA | SA/AA | 50/30/20 | ethanediol | 100 | hydroxyl group | 2100 |
| P-25 | PA/TPA | AA | 15/35/50 | ethanediol | 100 | hydroxyl group | 1000 |
| P-26 | PA/TPA | AA | 20/30/50 | ethanediol | 100 | hydroxyl group | 1000 |
| P-27 | PA/TPA | SA/AA | 15/35/20/30 | ethanediol | 100 | hydroxyl group | 1000 |
| P-28 | PA/TPA | SA/AA | 20/30/20/30 | ethanediol | 100 | hydroxyl group | 1000 |
| P-29 | PA/TPA | SA/AA | 10/50/30/10 | ethanediol | 100 | hydroxyl group | 1000 |
| P-30 | PA/TPA | SA/AA | 5/45/30/20 | ethanediol | 100 | hydroxyl group | 1000 |
| P-31 | — | AA | 100 | ethanediol | 100 | acetyl ester residue | 1000 |
| P-32 | — | AA | 100 | ethanediol | 100 | acetyl ester residue | 2000 |
| P-33 | — | AA | 100 | propanediol | 100 | acetyl ester residue | 2000 |
| P-34 | — | AA | 100 | butanediol | 100 | acetyl ester residue | 2000 |
| P-35 | — | AA | 100 | hexanediol | 100 | acetyl ester residue | 2000 |
| P-36 | — | AA/SA | 60/40 | ethanediol | 100 | acetyl ester residue | 900 |

TABLE 2

| | Dicarboxylic acid | | | Diol | | | |
|---|---|---|---|---|---|---|---|
| | Aromatic | Aliphatic Dicarboxylic | Dicarboxylic Acid Ratio | | Diol Ratio | | Number-Average |
| | Dicarboxylic Acid | Acid | (mol %) | Aliphatic Diol | (mol %) | Terminal Group | Molecular Weight |
| P-37 | — | AA/SA | 60/40 | ethanediol | 100 | acetyl ester residue | 1000 |
| P-38 | — | AA/SA | 60/40 | ethanediol | 100 | acetyl ester residue | 2000 |
| P-39 | — | SA | 100 | ethanediol | 100 | acetyl ester residue | 1000 |
| P-40 | — | SA | 100 | ethanediol | 100 | acetyl ester residue | 3000 |
| P-41 | — | SA | 100 | ethanediol | 100 | acetyl ester residue | 5500 |
| P-42 | — | SA | 100 | ethanediol | 100 | acetyl ester residue | 1000 |
| P-43 | PA | SA | 50/50 | ethanediol | 100 | acetyl ester residue | 1000 |
| P-44 | PA | SA | 50/50 | ethanediol | 100 | acetyl ester residue | 1500 |
| P-45 | PA | AA | 50/50 | ethanediol | 100 | acetyl ester residue | 2000 |
| P-46 | PA | SA/AA | 40/30/30 | ethanediol | 100 | acetyl ester residue | 1000 |
| P-47 | PA | SA/AA | 33/33/34 | ethanediol | 100 | benzoic acid residue | 1000 |
| P-48 | PA | SA/AA | 50/20/30 | ethanediol | 100 | acetyl ester residue | 1500 |
| P-49 | PA | SA/AA | 50/30/20 | ethanediol | 100 | acetyl ester residue | 2000 |
| P-50 | TPA | SA | 50/50 | ethanediol | 100 | acetyl ester residue | 1000 |
| P-51 | TPA | SA | 50/50 | ethanediol | 100 | acetyl ester residue | 1500 |
| P-52 | TPA | SA | 45/55 | ethanediol | 100 | acetyl ester residue | 1000 |
| P-53 | TPA | AA | 50/50 | ethanediol | 100 | acetyl ester residue | 2200 |
| P-54 | TPA | SA | 35/65 | ethanediol | 100 | acetyl ester residue | 1000 |
| P-55 | TPA | SA/AA | 40/30/30 | ethanediol | 100 | acetyl ester residue | 1000 |
| P-56 | TPA | SA/AA | 50/20/30 | ethanediol | 100 | acetyl ester residue | 1500 |
| P-57 | TPA | SA/AA | 50/30/20 | ethanediol | 100 | acetyl ester residue | 2000 |
| P-58 | TPA | SA/AA | 20/20/60 | ethanediol | 100 | acetyl ester residue | 1000 |
| P-59 | PA/TPA | AA | 15/35/50 | ethanediol | 100 | acetyl ester residue | 1000 |
| P-60 | PA/TPA | AA | 25/25/50 | ethanediol | 100 | acetyl ester residue | 1000 |
| P-61 | PA/TPA | SA/AA | 15/35/20/30 | ethanediol | 100 | acetyl ester residue | 1000 |
| P-62 | PA/TPA | SA/AA | 20/30/20/30 | ethanediol | 100 | acetyl ester residue | 1000 |
| P-63 | PA/TPA | SA/AA | 10/50/30/10 | ethanediol | 100 | acetyl ester residue | 1000 |
| P-64 | PA/TPA | SA/AA | 5/45/30/20 | ethanediol | 100 | acetyl ester residue | 1000 |
| P-65 | PA/TPA | SA/AA | 5/45/20/30 | ethanediol | 100 | acetyl ester residue | 1000 |
| P-66 | IPA | AA/SA | 20/40/40 | ethanediol | 100 | acetyl ester residue | 1000 |
| P-67 | 2,6-NPA | AA/SA | 20/40/40 | ethanediol | 100 | acetyl ester residue | 1200 |
| P-68 | 1,5-NPA | AA/SA | 20/40/40 | ethanediol | 100 | acetyl ester residue | 1200 |
| P-69 | 1,4-NPA | AA/SA | 20/40/40 | ethanediol | 100 | acetyl ester residue | 1200 |
| P-70 | 1,8-NPA | AA/SA | 20/40/40 | ethanediol | 100 | acetyl ester residue | 1200 |
| P-71 | 2,8-NPA | AA/SA | 20/40/40 | ethanediol | 100 | acetyl ester residue | 1200 |

In Table 1 and Table 2, PA is phthalic acid, TPA is terephthalic acid, IPA is isophthalic acid, AA is adipic acid, SA is succinic acid, 2,6-NPA is 2,6-naphthalenedicarboxylic acid, 2,8-NPA is 2,8-naphthalenedicarboxylic acid, 1,5-NPA is 1,5-naphthalenedicarboxylic acid, 1,4-NPA is 1,4-naphthalenedicarboxylic acid, 1,8-NPA is 1,8-naphthalenedicarboxylic acid.

Examples of the additive to the layer B include a low-molecular-weight additive. The low-molecular-weight additive includes a retardation controlling agent/regulating agent, a deterioration inhibitor, a UV absorbent, a peeling promoter, other plasticizer, IR absorbent, etc. These may be solid or oily. In other words, these are not specifically defined in point of the melting point or the boiling point thereof. For example, UV absorbing materials having a melting point of 20° C. or lower or a melting point of 20° C. or higher may be mixed; and similarly, deterioration inhibitors may be mixed. IR absorbent dyes described in JP-A2001-194522 are usable here.

One example of the low-molecular-weight additive is a retardation enhancer. When containing a retardation enhancer, the layer B secures high Re expressibility even at a low stretching draw ratio. The type of the retardation enhancer for use herein is not specifically defined. The retardation enhancer may include rod-shaped or discotic compounds. As the rod-shaped or discotic compound, a compound having at least two aromatic rings is preferred as the retardation enhancer for use herein. The amount to be added of the retardation enhancer of a rod-shaped compound is preferably from 0.5 to 10 parts by mass relative to 100 parts by mass of the cellulose acylate-containing polymer component, more preferably from 2 to 6 parts by mass. The discotic retardation enhancer may be used in an amount of from 0.5 to 10 parts by mass relative to 100 parts by mass of the cellulose acylate-containing polymer component, preferably from 1 to 8 parts by mass, more preferably from 2 to 6 parts by mass. Two or more different types of retardation enhancers may be used here as combined. Preferably, the retardation enhancer has a maximum absorption in a wavelength range of from 250 to 400 nm but does not substantially have an absorption in the visible range.

Preferably, triazine compounds represented by the following formula (I) are preferably used as the discotic compound.

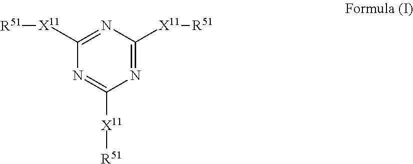

In the above formula (I),

R⁵¹ each independently represents an aromatic ring or a hetero ring having a substituent at any of ortho-, meta- and para-positions.

X¹¹ each independently represents a single bond or —NR⁵²—. In this, R⁵² each independently represent a hydrogen atom, or a substituted or unsubstituted alkyl, alkenyl, aryl or heterocyclic group.

Preferably, the aromatic ring represented by R⁵¹ is phenyl or naphthyl, more preferably phenyl. The aromatic ring represented by R⁵¹ is may have at least one substituent at any substitution position thereof. Examples of the substituent include a halogen atom, a hydroxyl group, a cyano group, a nitro group, a carboxyl group, an alkyl group, an alkenyl group, an aryl group, an alkoxy group, an alkenyloxy group, an aryloxy group, an acyloxy group, an alkoxycarbonyl group, an alkenyloxycarbonyl group, an aryloxycarbonyl group, a sulfamoyl group, an alkyl-substituted sulfamoyl group, an alkenyl-substituted sulfamoyl group, an aryl-substituted sulfamoyl group, a sulfonamide group, a carbamoyl group, an alkyl-substituted carbamoyl group, an alkenyl-substituted carbamoyl group, an aryl-substituted carbamoyl group, an amide group, an alkylthio group, an alkenylthio group, an arylthio group and an acyl group.

The heterocyclic group represented by R⁵¹ is preferably aromatic. The aromatic hetero ring is generally an unsaturated hetero ring and is preferably a hetero ring having a largest number of double bonds. Preferably, the hetero ring is a 5-membered ring, a 6-membered ring or a 7-membered ring, more preferably a 5-membered ring or a 6-membered ring, most preferably a 6-membered ring. Preferably, the hetero atom of the hetero ring is a nitrogen atom, a sulfur atom or an oxygen atom, more preferably a nitrogen atom. As the aromatic hetero ring, especially preferred is a pyridine ring (as the heterocyclic group thereof, 2-pyridyl or 4-pyridyl). The heterocyclic group may have a substituent. Examples of the substituent of the heterocyclic group are the same as those of the substituent of the above-mentioned aryl moiety.

The heterocyclic group in a case where X¹¹ is a single bond is preferably a heterocyclic group having a free atomic valence at the nitrogen atom thereof. The heterocyclic group having a free atomic valence at the nitrogen atom thereof is preferably a 5-membered ring, a 6-membered ring or a 7-membered ring, more preferably a 5-membered ring or a 6-membered ring, most preferably a 5-membered ring. The heterocyclic group may have multiple nitrogen atoms. The heterocyclic group may have any other hetero atom (e.g., O, S) than the nitrogen atom. Examples of the heterocyclic group having a free atomic valence at the nitrogen atom thereof are mentioned below.

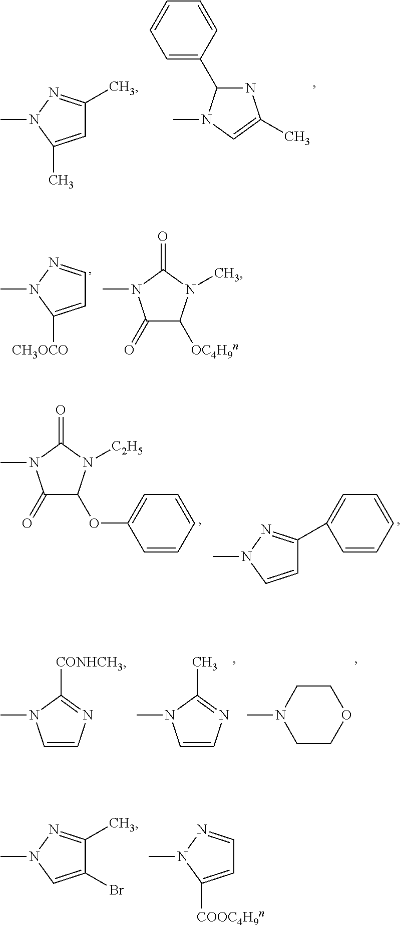

The alkyl group represented by R⁵² may be a cyclic alkyl group or a chain-like alkyl group, but is preferably a chain-like alkyl group, more preferably a linear alkyl group rather than a branched chain-like alkyl group. The carbon number of the alkyl group is preferably from 1 to 30, more preferably from 1 to 20, even more preferably from 1 to 10, still more preferably from 1 to 8, most preferably from 1 to 6. The alkyl group may have a substituent. Examples of the substituent include a halogen atom, an alkoxy group (for example, methoxy group, ethoxy group) and an acyloxy group (for example, acryloyloxy group, methacryloyloxy group).

The alkenyl group represented by R⁵² may be a cyclic alkenyl group or a chain-like alkenyl group, but is preferably a chain-like alkenyl group, more preferably a linear alkenyl group rather than a branched chain-like alkenyl group. The carbon number of the alkenyl group is preferably from 2 to 30, more preferably from 2 to 20, even more preferably from 2 to 10, still more preferably from 2 to 8, most preferably from 2 to 6. The alkenyl group may have a substituent. Examples of the substituent are the same as those of the substituent of the alkyl group mentioned above.

The aromatic cyclic group and the heterocyclic group represented by R⁵² are the same as the aromatic ring and the hetero ring represented by R⁵¹, and preferred examples of the former are also the same as those of the latter. The aromatic cyclic group and the heterocyclic group may be further substituted, and examples of the substituent for these are the same as those of the substituent for the aromatic cyclic group and the heterocyclic group of R⁵¹.

The layer B may be a film, and is preferably a cellulose acylate-based film that contains a cellulose acylate as the main ingredient thereof. The method for producing the film is not specifically defined. A film formed according to any of a solution casting method or a melt casting method is usable for the layer B. The above-mentioned cellulose acylate having a low degree of acylation is preferred here from the viewpoint of the SP value and the optical characteristics thereof, but may be inferior to a cellulose acylate having a high degree of acylation in point of the film formability thereof. For example, in producing the film according to a solution casting method, the film formed could hardly peel away from the support drum or belt on which the film dope has been cast, therefore often having a problem of peeling failure. For solving the problem, a solution of a cellulose acylate having a low degree of acylation and a solution of a cellulose acylate having a high degree of acylation (for example, at least 2.75) are used, and the former is a dope for core layer formation while the latter is a dope for skin layer formation on one side or on both sides of the core layer; and the film thus formed by co-casting the two solutions may be used as the layer B herein. In the embodiment of the co-cast film, when the thickness of the core layer is significantly larger than the thickness of the skin layer so that the core layer accounts for a major of the co-cast film, then the cellulose acylate having a low degree of acylation could be the main ingredient of the layer B.

In the embodiment where the layer B is a film, the film may be processed for stretching treatment, shrinking treatment or any other treatment for regulating the optical characteristics thereof in order to make the film satisfy the above-mentioned optical characteristics for the layer B. The stretching treatment may be monoaxial treatment of stretching the film only in one direction (for example, in MD or TD) or may be a biaxial treatment of stretching the film in two directions (for example, in MD and TD).

One example of the layer B is a film comprising, as the main ingredient thereof, a cellulose acetate having a total degree of acyl substitution of from 2.2 to 2.5 and optionally containing the above-mentioned high-molecular-weight additive, and the film is, after formed according to a solution casting method, monoaxially and/or biaxially stretched at a stretching temperature of from 170 to 200° C. and at a draw ratio of from 40 to 80%, and has a thickness of from 25 to 80 w. The SP value of the cellulose acylate having a total degree of acyl substitution of from 2.2 to 2.5 is from 22.9 to 23.9 or so.

### Layer C:

The layer C is a so-called negative C-plate that satisfies the following formulae (Ic) and (IIc):

Re(550)≦10 nm (Ic):

−200 nm≦Rth(550)≦−50 nm (IIc):

Preferably, the layer C satisfies the following two formulae, from the viewpoint of improving the viewing angle characteristics of horizontal alignment mode liquid crystal display devices comprising it:

−8≦Re(550)≦8 nm (Ic′):

−160 nm≦Rth(550)≦−55 nm (IIc′):

Even more preferably, the layer C satisfies the following two formulae:

−6≦Re(550)≦6 nm (Ic″):

−150 nm≦Rth(550)≦−60 nm (IIc″):

The layer satisfying the above-mentioned optical characteristics includes a layer containing, as the main ingredient thereof, a non-liquid crystalline polymer organic compound, and a layer formed by fixing the homeotropic alignment of a composition that contains rod-shaped liquid crystal molecules as the main ingredient thereof.

The non-liquid crystalline polymer organic compound used as the main ingredient of the layer C is preferably selected from a non-liquid crystalline organic compound having an inherent negative birefringence. Examples of the non-liquid crystalline organic compound having an inherent negative birefringence include fumarate resins, polystyrene derivatives and styrenic copolymers. These are described below.

The fumarate resin usable as the main ingredient of the layer C includes a fumarate polymer, and is preferably a fumaric diester resin that comprises a fumaric diester residue unit represented by the following general formula (a) in an amount of at least 50 mol %.

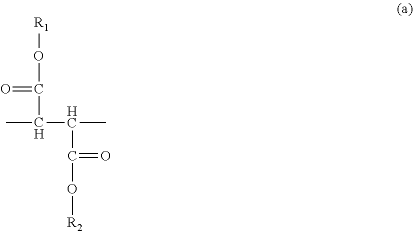

R₁ and R₂ each independently represent a branched alkyl group or a cyclic alkyl group having from 3 to 12 carbon atoms.

R₁ and R₂ that are the ester substituents of the fumaric diester residue unit each are independently a branched alkyl or cyclic alkyl group having from 3 to 12 carbon atoms, which may be substituted with a halogen atom such as fluorine, chlorine or the like, or with an ether group, an ester group or an amino group. For example, there are mentioned an isopropyl group, an s-butyl group, a t-butyl group, an s-pentyl group, a t-pentyl group, an s-hexyl group, a t-hexyl group, a cyclopropyl group, a cyclopentyl group, a cyclohexyl group, etc. Preferred are an isopropyl group, an s-butyl group, a t-butyl group, a cyclopentyl group, a cyclohexyl group, etc.; and more preferred is an isopropyl group.

Examples of the fumaric diester residue unit represented by the general formula (a) include a diisopropyl fumarate residue, a di-s-butyl fumarate residue, a di-t-butyl fumarate residue, a di-s-pentyl fumarate residue, a di-t-pentyl fumarate residue, a di-s-hexyl fumarate residue, a di-t-hexyl fumarate residue, a dicyclopropyl fumarate residue, a dicyclopentyl fumarate residue, a dicyclohexyl fumarate residue. Preferred are a diisopropyl fumarate residue, a di-s-butyl fumarate residue, a di-t-butyl fumarate residue, a dicyclopentyl fumarate residue, a dicyclohexyl fumarate residue, etc.; and more preferred is a diisopropyl fumarate residue.

Preferably, the main ingredient of the layer C is a fumarate resin that comprises a fumaric diester residue represented by the general formula (a) in an amount of at least 50 mol %, and is more preferably a resin that comprises a fumaric diester residue unit represented by the general formula (a) in an amount of at least 50 mol % and a residue unit of a monomer copolymerizable with a fumaric diester in an amount of at most 50 mol %. The residue unit of a monomer copolymerizable with a fumaric diester includes, for example, one or more selected from styrenic residues such as a styrene residue, an α-methylstyrene residue, etc.; an acrylic acid residue; acrylate residues such as a methyl acrylate residue, an ethyl acrylate residue, a butyl acrylate residue, a 3-ethyl-3-oxetanylmethyl acrylate residue, a tetrahydrofurfuryl acrylate residue, etc.; a methacrylic acid residue; methacrylate residues such as a methyl methacrylate residue, an ethyl methacrylate residue, a butyl methacrylate residue, a 3-ethyl-3-oxetanylmethyl methacrylate residue, a tetrahydrofurfuryl methacrylate residue, etc.; vinyl ester residues such as a vinyl acetate residue, a vinyl propionate residue, etc.; an acrylonitrile residue; a methacrylonitrile residue; an olefinic residue such as an ethylene residue, a propylene residue, etc. Of the above, preferred are a 3-ethyl-3-oxetanylmethyl acrylate residue, a 3-ethyl-3-oxetanylmethyl methacrylate residue; and more preferred is a 3-ethyl-3-oxetanylmethyl acrylate residue. Of those, preferred is a resin that comprises the fumaric diester residue unit of the general formula (a) in an amount of at least 70 mol %; more preferred is a resin that comprises the fumaric diester residue unit in an amount of at least 80 mol %; and even more preferred is a resin that comprises the fumaric diester residue in an amount of at least 90 mol %. Needless-to-say, a resin that comprises the fumaric diester residue of the general formula (a) alone is also preferred.

Preferably, the polystyrene-equivalent number-average molecular weight (Mn) of the fumaric ester resin to be used as the main ingredient of the layer C, as obtained from the elution curve in gel permeation chromatography (hereinafter referred to as GPC), is at least 1×10⁴, more preferably from 2×10⁴ to 2×10⁵, from the viewpoint that the resin can form an optically compensatory film excellent in forming workability in film formation.

The method for producing the fumarate resin is not specifically defined, for which employable are various methods. For example, the resin may be formed through radical polymerization or radical copolymerization using a fumaric diester optionally along with a monomer copolymerizable with a fumaric diester. The starting fumaric diester includes, for example, diisopropyl fumarate, di-s-butyl fumarate, di-t-butyl fumarate, di-s-pentyl fumarate, di-t-pentyl fumarate, di-s-hexyl fumarate, di-t-hexyl fumarate, dicyclopropyl fumarate, dicyclopentyl fumarate, dicyclohexyl fumarate, etc. The monomer copolymerizable with a fumaric diester includes, for example, one or more selected from styrenes such as styrene, α-methylstyrene; acrylic acid; acrylates such as methyl acrylate, ethyl acrylate, butyl acrylate, 3-ethyl-3-oxetanylmethyl acrylate, tetrahydrofurfuryl acrylate; methacrylic acid; methacrylates such as methyl methacrylate, ethyl methacrylate, butyl methacrylate, 3-ethyl-3-oxetanylmethyl methacrylate, tetrahydrofurfuryl methacrylate, etc.; vinyl esters such as vinyl acetate, vinyl propionate, etc.; acrylonitrile; methacrylonitrile; olefins such as ethylene, propylene, etc. Of those, preferred are 3-ethyl-3-oxetanylmethyl acrylate and 3-ethyl-3-oxetanylmethyl methacrylate; and more preferred is 3-ethyl-3-oxetanylmethyl acrylate.

The radical polymerization may be attained according to any known polymerization method. For example, employable is any of a bulk polymerization method, a solution polymerization method, a suspension polymerization method, a precipitation polymerization method, an emulsion polymerization method, etc.

The polymerization in initiator in the radical polymerization method includes, for example, an organic peroxide such as benzoyl peroxide, lauryl peroxide, octanoyl peroxide, acetyl peroxide, di-t-butyl peroxide, t-butylcumyl peroxide, dicumyl peroxide, t-butyl peroxyacetate, t-butyl peroxybenzoate, t-butyl peroxypivalate, etc.; and an azo-type initiator such as 2,2′-azobis(2,4-dimethylvaleronitrile), 2,2′-azobis(2-butyronitrile), 2,2′-azobisisobutyronitrile, dimethyl 2,2′-azobisisobutyrate, 1,1′-azobis(cyclohexane-1-carbonitrile), etc.

Not specifically defined, the solvent usable in the solution polymerization method, the suspension polymerization method, the precipitation polymerization method and the emulsion polymerization method includes, for example, aromatic solvents such as benzene, toluene, xylene, etc.; alcohol solvents such as methanol, ethanol, propyl alcohol, butyl alcohol, etc.; cyclohexane; dioxane; tetrahydrofuran (THF); acetone; methyl ethyl ketone; dimethylformamide; isopropyl acetate; water, etc., and their mixed solvents are also usable here.

The polymerization temperature in radical polymerization may be suitably defined depending on the decomposition temperature of the polymerization initiator used, and is preferably within a range of from 40 to 150° C.

Other examples of the non-liquid crystalline polymer organic compound usable as the main ingredient of the layer C include polymers and copolymers of a monomer of which the homopolymer exhibits a negative birefringence. For example, there are mentioned acrylic monomers, cellulose benzoate monomers, aromatic ring-having monomers such as styrenic monomers, and ethylenic unsaturated monomers, etc. Of those, preferred are acrylic monomers styrenic derivative monomers and vinylpyrrolidone-type monomers. More preferred are styrenic monomers and vinylpyrrolidone; and most preferred are styrenic derivative monomers.

Preferred examples of the non-liquid crystalline polymer organic compound usable as the main ingredient of the layer C are polystyrene derivatives and styrenic copolymers. Concretely, there are mentioned homopolymers and copolymers of a styrenic monomer. The styrenic copolymer may be a copolymer of two or more different types of styrenic monomers, or a copolymer of at least one styrenic monomer and at least one non-styrenic monomer (for example, acrylic monomer, preferably acrylic monomer represented by the formula (c) mentioned below).

Examples of the styrenic monomer include a monomer derived from styrene by substituting at least one hydrogen of the ethenyl group therein with a substituent, and a monomer derived from styrene by substituting at least one hydrogen of the phenyl group therein with a substituent. Preferred is a styrenic monomer having a substituent in the phenyl group therein. The substituent includes an alkyl group, a halogen atom, an alkoxy group, an acetoxyl group, a carboxyl group, as well as an amino group, a nitro group, a cyano group, an aryl group, a hydroxyl group, a carbonyl group. Preferred is a hydroxyl group, a carbonyl group or an acetoxyl group; and more preferred is a hydroxyl group or an acetoxyl group. The monomer may have one or more such substituents either singly or as combined. In addition, the substituent may be further substituted. The styrenic derivative monomer may be in the form of a condensed ring in which the phenyl group is condensed with any other aromatic ring, or may also be in any other form where the substituent forms any other ring than the phenyl group therein, such as an indenes, indanes, etc., or may also be in the form of a structure having a crosslinked ring.

The styrenic monomer is preferably an aromatic vinylic monomer represented by the following general formula (b):

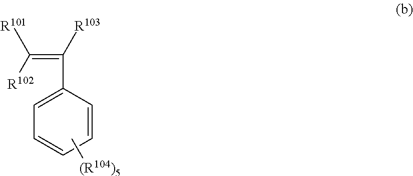

In the formula, R¹⁰¹ to R¹⁰⁴ each independently represent a hydrogen atom, a halogen atom, or a substituted or unsubstituted hydrocarbon atoms having from 1 to 30 carbon atoms and optionally having a linking group containing an oxygen atom, a sulfur atom, a nitrogen atom or a nitrogen atom, or represents a polar group; R¹⁰⁴'s all may be the same atoms or groups, or each may be a different atom or group, or they may bond to each other to form a carbon ring or a hetero ring (and the carbon ring and the hetero ring may be a monocyclic structure or may form a polycyclic structure as condensed with any other ring).

Specific examples of the aromatic vinylic monomer include styrene; alkyl-substituted styrenes such as α-methylstyrene, β-methylstyrene, p-methylstyrene, etc.; halogen-substituted styrenes such as 4-chlorostyrene, 4-bromostyrene, etc.; hydroxystyrenes such as p-hydroxystyrene, α-methyl-p-hydroxystyrene, 2-methyl-4-hydroxystyrene, 3,4-dihydroxystyrene, etc.; vinylbenzyl alcohols; alkoxy-substituted styrenes such as p-methoxystyrene, p-tert-butoxystyrene, m-tert-butoxystyrene, etc.; vinylbenzoic acids such as 3-vinylbenzoic acid, 4-vinylbenzoic acid, etc.; vinyl benzoates such as methyl 4-vinylbenzoate, ethyl 4-vinylbenzoate, etc.; 4-vinylbenzyl acetate; 4-acetoxystyrene; amidestyrenes such as 2-butylamidestyrene, 4-methylamidestyrene, p-sulfonamidestyrene, etc.; aminostyrenes such as 3-aminostyrene, 4-aminostyrene, 2-isopropenylaniline, vinylbenzyldimethylamine, etc.; nitrostyrenes such as 3-nitrostyrene, 4-nitrostyrene, etc.; cyanostyrenes such as 3-cyanostyrene, 4-cyanostyrene, etc.; vinylphenylacetonitrile; arylstyrenes such as phenylstyrene, etc.; indenes, etc. However, the invention is not limited to these specific examples. Two or more different types of such monomers may be used as the copolymerization component here.

The acrylic monomer may be selected, for example, from the monomers represented by the following formula (c):

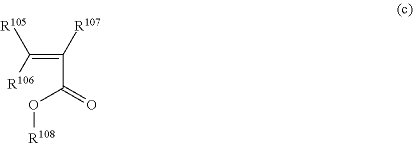

In the formula, R¹⁰⁵ to R¹⁰⁸ each independently represent a hydrogen atom, a halogen atom, or a substituted or unsubstituted hydrocarbon atoms having from 1 to 30 carbon atoms and optionally having a linking group containing an oxygen atom, a sulfur atom, a nitrogen atom or a nitrogen atom, or represents a polar group.

Examples of the acrylate monomer include, for example, methyl acrylate, ethyl acrylate, propyl (i-, n-) acrylate, butyl (n-, i-, s-, tert-) acrylate, pentyl (n-, i-, s-) acrylate, hexyl (n-, i-) acrylate, heptyl (n-, i-) acrylate, octyl (n-, i-) acrylate, nonyl (n-, i-) acrylate, myristyl (n-, i-) acrylate, 2-ethylhexyl) acrylate, (ε-caprolactone) acrylate, (2-hydroxyethyl) acrylate, (2-hydroxypropyl) acrylate, (3-hydroxypropyl) acrylate, (4-hydroxybutyl) acrylate, (2-hydroxybutyl) acrylate, (2-methoxyethyl) acrylate, (2-ethoxyethyl) acrylate, phenyl acrylate, phenyl methacrylate, (2- or 4-chlorophenyl) acrylate, (2- or 4-chlorophenyl) methacrylate, (2-, 3- or 4-ethoxycarbonylphenyl) acrylate, (2-, 3- or 4-ethoxycarbonylphenyl) methacrylate, (o- or m- or p-tolyl) acrylate, (o- or m- or p-tolyl) methacrylate, benzyl acrylate, benzyl methacrylate, phenethyl acrylate, phenethyl methacrylate, (2-naphthyl) acrylate, cyclohexyl acrylate, cyclohexyl methacrylate, (4-methylcyclohexyl) acrylate, (4-methylcyclohexyl) methacrylate, (4-ethylcyclohexyl) acrylate, (4-ethylcyclohexyl) methacrylate; and methacrylates corresponding to the above-mentioned acrylates. However, the invention is not limited to these specific examples. Two or more different types of these monomers may be used as the copolymerization component here. Of those, preferred are methyl acrylate, ethyl acrylate, propyl (i-, n-) acrylate, butyl (n-, i-, s-, tert-) acrylate, pentyl (n-, i-, s-) acrylate, hexyl (n-, i-) acrylate, and methacrylates corresponding to these acrylates, from the viewpoint of availability and inexpensiveness.

As the main ingredient of the layer C, preferred is a homopolymer or a copolymer having a recurring unit derived from a monomer of which the homopolymer exhibits a negative birefringence. Examples of the monomer of the type include styrene; alkyl-substituted styrenes such as α-methylstyrene, β-methylstyrene, p-methylstyrene, etc.; halogen-substituted styrenes such as 4-chlorostyrene, 4-bromostyrene, etc.; hydroxystyrenes such as p-hydroxystyrene, α-methyl-p-hydroxystyrene, 2-methyl-4-hydroxystyrene, 3,4-dihydroxystyrene, etc.; vinylbenzyl alcohols; alkoxy-substituted styrenes such as p-methoxystyrene, p-tert-butyoxystyrene, m-tert-butoxystyrene, etc.; vinylbenzoic acids such as 3-vinylbenzoic acid, 4-vinylbenzoic acid, etc.; vinyl benzoates such as methyl 4-vinylbenzoate, ethyl 4-vinylbenzoate, etc.; 4-vinylbenzyl acetate; 4-acetoxystyrene; amidestyrenes such as 2-butylamidestyrene, 4-methylamidestyrene, p-sulfonamidestyrene, etc.; aminostyrenes such as 3-aminostyrene, 4-aminostyrene, 2-isopropenylaniline, vinylbenzyldimethylamine, etc.; nitrostyrenes such as 3-nitrostyrene, 4-nitrostyrene, etc.; cyanostyrenes such as 3-cyanostyrene, 4-cyanostyrene, etc.; vinylphenylacetonitrile; arylstyrenes such as phenylstyrene, etc.; indenes, etc. Of those, preferred are styrene, hydroxystyrene, acetoxystyrene and vinylpyrrolidone; and more preferred are styrene, m-hydroxystyrene, o-hydroxystyrene, m-acetoxystyrene, o-acetoxystyrene and vinylpyrrolidone.

One or more different types of surfactant may be added to the layer C that contains the above-mentioned, non-liquid crystalline polymer organic compound as the main ingredient thereof. Regarding the examples of the usable additive and the preferred range of the amount thereof to be added, referred to is the description in paragraphs [0033] to [0041] in JP-A 2009-168900.

The SP value of the fumarate resins, the polystyrene derivatives and the styrenic copolymers exemplified hereinabove as the non-liquid crystalline polymer organic compound is generally from 17 to 20.5 or so. Accordingly, when the layer C that contains the non-liquid crystalline polymer organic compound of the type as the main ingredient thereof and the layer B that contains the above-mentioned cellulose acylate having a total degree of acyl substitution of from 2.2 to 2.5 as the main ingredient thereof are combined, then |ΔSP| could be at least 2.6, and therefore the combination of those layers is preferred in the invention.

The morphology of the layer C that contains the above-mentioned non-liquid crystalline polymer organic compound as the main ingredient thereof is not specifically defined. The layer C may be a self-supporting film that contains the non-liquid crystalline polymer organic compound as the main ingredient thereof, or may also be a non-self-supporting layer formed by coating with a composition that contains the non-liquid crystalline polymer organic compound as the main ingredient thereof. An embodiment of the former includes a film formed through film formation according to a solution casting method or a melt casting method. An embodiment of the latter includes a case where the layer B is a self-supporting film and serves as a support for the layer C.

One example of the method for forming the layer C comprises applying a coating liquid that contains a polymer organic compound as the main ingredient thereof, onto the surface of the layer B formed of a film, followed by drying it thereon. The solvent to be used in preparing the coating liquid is not specifically defined. Depending on the solubility therein of the main ingredient, the solvent may be suitably selected. For example, the solvent includes toluene; ketones such as methyl ethyl ketone (MEK), acetone, methyl butyl ketone, methyl isobutyl ketone, methyl isopropyl ketone, cyclohexanone, etc.; esters such as ethyl acetate, butyl acetate, ethyl lactate, γ-butyrolactone, propylene glycol monomethyl ether acetate, propylene glycol monoethyl ether acetate, etc.; ethers such as ethylene glycol monomethyl ether, diethylene glycol monobutyl ether, etc.; aromatic hydrocarbons such as benzene, toluene, xylene, etc.; amides such as dimethylformamide, dimethylacetamide, N-methylpyrrolidone, etc. A mixed solvent of two or more of the above is also usable here.

The coating method is not specifically defined. Various methods are employable here, including a spin coating method, a dip coating method, a curtain coating method, an extrusion coating method, a rod coating method, a roll coating method, etc.

Another example of the layer C is a layer formed by fixing the homeotropic alignment of a liquid crystal composition that contains rod-shaped liquid crystal molecules as the main ingredient thereof. The layer formed by fixing the homeotropic alignment of rod-shaped liquid crystal molecules functions as a negative C-plate and exhibits the optical characteristics that are required for the layer C. The main ingredient of the layer is, when a low-molecular-weight rod-shaped liquid crystal is contained in the layer directly as it is therein, the rod-shaped liquid crystal; but on the other hand, when a high-molecular-weight polymer formed through polymerization of a polymerizing rod-shaped liquid crystal is contained in the layer, then the high-molecular-weight polymer rod-shaped liquid crystal is the main ingredient of the layer. In any case, the SP value of the layer is calculated in the condition thereof as above.

Rod-shaped liquid crystals usable herein are described, for example, in JP-A 2009-217256, [0045] to [0066], and the description may be referred to here. The usable additive, the usable alignment film and the method for forming the homeotropic liquid crystal layer are described, for example, in JP-A 2009-237421, [0076] to [0079], and the description may be referred to here.

The thickness of the layer C is not specifically defined. In case where the layer C is formed by coating, in general, its thickness may be from 0.5 to 20 μm or so (preferably from 1.0 to 15 μm). In case where the layer C is in the form of a film, the thickness thereof may be on the same level as that of the above-mentioned layer B.

### Optical Laminate Film:

Having the layer B and the layer C that satisfy the above-mentioned conditions, the optical laminate film of the invention is not specifically defined in point of any other characteristics thereof and its production method. Regarding the production method, the layer B and the layer C may be integrated according to any method of a coating method, a co-casting method, a lamination method with an adhesive, etc.

In an embodiment where the layer B and the layer C are adjacent to each other, there may often occur interface irregular; and therefore in the invention is especially effective to the embodiment where the layer B and the layer C are adjacent to each other. In particular, the invention is favorable to the embodiment where at least one of the layer B and the layer C, preferably the layer C is formed by coating that may often cause interface irregular.

The thickness of the optical laminate film is not specifically defined. In use for optical films in liquid crystal display devices, in general, the thickness may be from 30 to 100 μm; however, for satisfying the requirement for film thickness reduction, the thickness of the optical laminate film is preferably at most 80 μm, more preferably from 30 to 70 μm. For example, in case where a film is used as the layer B and the layer C is formed thereon by coating, then an adhesive layer may be omitted and the thickness of the resulting laminate film may be thereby reduced. Further, in case where a cellulose acylate having a total degree of acylation of from 2.2 to 2.5 as mentioned above is used as the film for the layer B, the embodiment is favorable as attaining the optical characteristics necessary for the layer B owing to the excellent optical characteristics expressibility of the layer B even though the layer is thin and as capable of further reducing the thickness of the resulting laminate film.

### 2. Polarizer

The invention also relates to a polarizer having the optical laminate film of the invention and a polarizing element. The optical laminate film of the invention may function as a protective film for the polarizing element. The polarizing element may be any conventional known one. For example, the polarizing element may be produced by processing a hydrophilic polymer film such as a polyvinyl alcohol film with a dichroic dye such as iodine followed by stretching it. Not specifically defined, the cellulose acylate film may be stuck to the polarizing element in any manner. For example, the two may be stuck to each other with an adhesive of an aqueous solution of a water-soluble polymer. The water-soluble polymer adhesive is preferably an aqueous solution of a completely-saponified polyvinyl alcohol.

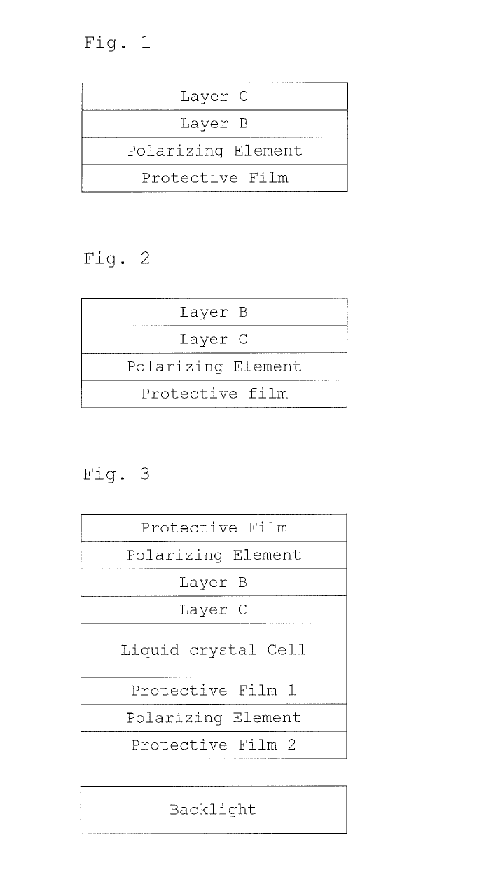

In the polarizer of the invention, the positional relationship between the layer B and the layer C, and the polarizing element is not specifically defined. For example, herein employable is a configuration of layer C/layer B/polarizing element as shown in FIG. 1, or a configuration of layer B/layer C/polarizing element as shown in FIG. 2. The former embodiment is suitable for a polarizer for IPS-mode liquid crystal display devices among horizontal alignment mode devices; and the latter embodiment is suitable for a polarizer for FFS-mode liquid crystal display devices among horizontal alignment mode devices.

As shown in FIG. 1 and FIG. 2, preferably, a protective film is stuck to the other surface of the polarizing element opposite to the surface thereof to which the optical laminate film of the invention is stuck. The protective film is not specifically defined, for which is employable any polymer film such as a film of cellulose acylate, cyclic olefin polymer, polycarbonate, polysulfone, polyether sulfone, polyacrylate, polymethacrylate or the like.

3. Horizontal Alignment Mode Liquid crystal Display Device

The invention also relates to a horizontal alignment mode liquid crystal display device having the optical laminate film of the invention. The horizontal alignment mode includes IPS mode and FFS mode.

In the display device, preferably, the optical laminate film of the invention is, serving as an optical compensation film, arranged between the liquid crystal cell and the polarizing element, or is arranged therein preferably at a site of any one between the polarizing element on the panel side and the liquid crystal cell or between the polarizing element on the backlight side and the liquid crystal cell. The optical laminate film of the invention may be mounted on the liquid crystal display device as integrated with the polarizing element therein to be a member of the polarizer therein.

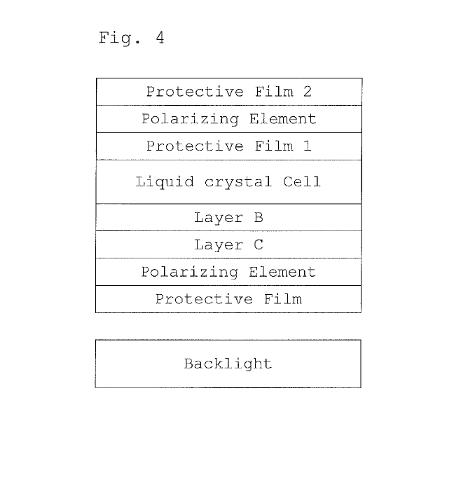

FIG. 3 and FIG. 4 each show a schematic cross-sectional view of an example of the liquid crystal display device of the invention. The case of FIG. 3 is an example in which the invention is applied to an IPS mode; and the case of FIG. 4 is an example in which the invention is applied to an FFS mode. In FIG. 3 and FIG. 4, the relative relationship regarding the thickness of each layer does not always correspond to the actual thickness of each layer.

The liquid crystal display device shown in FIG. 3 is an example in which the polarizer of the invention is arranged on the panel side thereof. In this example, the optical laminate film of the invention is arranged, serving as an optical compensatory film therein, between the liquid crystal cell and the polarizing element on the panel side. In this example, preferably, the layer C is arranged on the side of the liquid crystal cell and the layer B is on the side of the polarizing element therein. This case is especially suitable as an IPS-mode liquid crystal display device.

The liquid crystal display device shown in FIG. 4 is an example in which the polarizer of the invention is arranged on the backlight side thereof. In this example, the optical laminate film of the invention is arranged, serving as an optical compensatory film therein, between the liquid crystal cell and the polarizing element on the backlight side. In this example, preferably, the layer B is arranged on the side of the liquid crystal cell and the layer C is on the side of the polarizing element therein. This case is especially suitable as an FFS-mode liquid crystal display device.

In FIG. 3 and FIG. 4, the polarizer to be arranged in the device along with the polarizer of the invention therein on the opposite side so as to sandwich the liquid crystal cell therebetween is not specifically defined. In general, the polarizer is so configured that the polarizing element is sandwiched between protective films stuck to both surfaces thereof. In FIG. 3 and FIG. 4, the protective film 1 arranged between the liquid crystal cell and the polarizing element is preferably one having a low Re and a low Rth, and is, for example, preferably a commercial product, Z-TAC (by FUJIFILM), etc. The protective film 2 is not specifically defined, and may be the same as the above-mentioned protective film.

### EXAMPLES

The invention is described more concretely with reference to Examples given below. In the following Examples, the material used, its amount and ratio, the details of the treatment and the treatment process may be suitably modified or changed and the scope of the invention. Accordingly, the scope of the invention should not be limited to the following Examples.

### 1. Production of Film for Layer B

### (1) Production of Cellulose Acylate Film for Layer B

A cellulose acylate film for layer B was produced according to the method mentioned below.

### (1)-1 Preparation of Dope

### Preparation of Cellulose Acylate Solution:

The following ingredients were put into a mixing tank and dissolved by stirring, then heated at 90° C. for about 10 minutes, and thereafter filtered through a paper filter having a mean pore size of 34 μm and a sintered metal filter having a mean pore size of 10 μm.

### Cellulose Acylate Solution of Example 1

| | |
|---|---|
| Cellulose acylate shown in the table | 100 parts by mass in total |
| High-molecular-weight additive shown in | (amount shown in the table, |
| the table | unit: part by mass) |
| Low-molecular-weight additive shown in | (amount shown in the table, |
| the table | unit: part by mass) |
| Methylene chloride | 403.0 parts by mass |
| Methanol | 60.2 parts by mass |

TABLE 3
High-Molecular-Weight Additive B1

| | | Dicarboxylic Acid Unit | | | | Glycol Unit | | | |
|---|---|---|---|---|---|---|---|---|---|
| | | terephthalic | phthalic | | | ethylene | | PG | |
| | Molecular | acid | acid | adipic acid | succinic acid | glycol | 1,2-propanediol | Ratio | Terminal |
| Type | Weight | (mol %) | (mol %) | (mol %) | (mol %) | (mol %) | (mol %) | [%] | Group |
| B1 | 800 | 55 | 0 | 0 | 45 | 50 | 50 | 50 | AC |

### Low-Molecular-Weight Additive A1

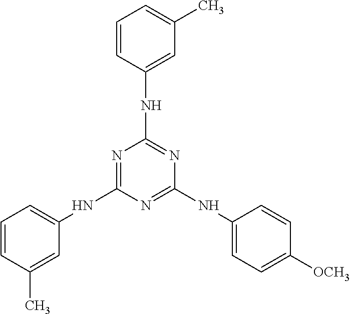 [SMILES: COc1ccc(Nc2nc(Nc3cccc(C)c3)nc(Nc3cccc(C)c3)n2)cc1]

### Preparation of Mat Agent Dispersion:

The following ingredients including the cellulose acylate solution prepared according to the above-mentioned method were put into a disperser to prepare a mat agent dispersion.

Mat Agent Dispersion

| | |
|---|---|
| Mat agent (Aerosil R972) | 0.2 parts by mass |
| Methylene chloride | 72.4 parts by mass |
| Methanol | 10.8 parts by mass |
| Cellulose acylate solution | 10.3 parts by mass |

100 parts by mass of the cellulose acylate solution and the above-mentioned mat agent dispersion were mixed in such a ratio that the amount of the inorganic fine particles therein could be 0.02 parts by mass relative to the cellulose acylate, thereby preparing a dope for film formation.

### (1)-2 Casting

The above-mentioned dope was cast onto a band caster. The band was a SUS-made one.

### (1)-3 Drying

The web (film) formed by casting was peeled from the band, conveyed on pass rolls and dried at a drying temperature of 120° C. for 20 minutes. The drying temperature as referred to herein means the temperature of the film surface.

### (1)-4 Stretching

The formed web (film) was peeled from the band, clipped, and in an end-fixed monoaxial stretching mode using a tenter, this was stretched at the stretching temperature and the stretching draw ratio as indicated in Table 4, in the direction (TD, transverse direction) perpendicular to the film conveying direction (MD, machine direction).

The cellulose acylate films 12 and 13 were stretched in TD at 185° C., while relaxed in MD, in the tenter zone.

In Table 4 below, the stretching draw ratio and the stretching temperature are shown. In this, “−” means shrinking.

### (2) Production of Polycarbonate Film for Layer B

Panlight L1225 was bought from Teijin, and dissolved in dichloromethane to be 20% by weight, thereby preparing a dope. The dope was cast in a mode of solution casting for film formation, and dried to prepare a polycarbonate film. The film was cut into a square piece of 50 mm×50 mm, and the piece was stretched by 1.5 times in a free-end monoaxial stretching mode at a temperature of 170° C. and at a drawing rate of 10 mm/min, using a biaxial stretcher (by Imoto Machinery).

### (2) Production of Cyclic Olefin for Layer B

Zeonoa's ZF14 was stretched by 1.5 times in a free-end monoaxial stretching mode at a temperature of 140° C. and at a drawing rate of 30 mm/min.

### (3) Production Conditions for Films and Characteristics of Films

The production conditions for cellulose acylate films and polycarbonate films and the characteristics of the films are shown in Table 4 below.

TABLE 4

| No. of | | Degree | | | | | | | | | | |
|---|---|---|---|---|---|---|---|---|---|---|---|---|
| Film | | of Ac | | | | Stretching | | Characteristics | | | | |
| for | | Sub- | SP | Additive | | Temperature, | | Thickness | Re | Rth | | Photoelasticity |
| Layer B | Material | stitution | Value | Type | Amount | ° C. | Draw Ratio % | μm | nm | nm | Nz | (MD, TD average) |
| Film 1 | cellulose acetate | 2.10 | 24.2 | B1 | 12 | 190 | 60 | 55 | 150 | 150 | 1.5 | 22 |
| Film 2 | cellulose acetate | 2.41 | 23.1 | B1 | 12 | 190 | 60 | 55 | 110 | 105 | 1.5 | 17 |
| Film 3 | cellulose acetate | 2.71 | 22.2 | B1 | 12 | 190 | 60 | 55 | 72 | 75 | 1.5 | 16 |
| Film 4 | cellulose acetate | 2.79 | 22.0 | B1/AA1 | 12/3 | 190 | 60 | 55 | 80 | 80 | 1.5 | 18 |
| Film 5 | cellulose acetate | 2.86 | 21.9 | B1 | 12 | 190 | 60 | 55 | 10 | 30 | 3.5 | 15 |
| Film 6 | polycarbonate | — | 21.7 | — | — | 170 | free width 50 | 75 | 125 | 70 | 1.1 | 95 |
| Film 7 | cellulose acetate | 2.41 | 23.1 | B1 | 12 | 190 | 60 | 55 | 100 | 90 | 1.4 | 16 |
| Film 8 | cellulose acetate | 2.41 | 23.1 | B1 | 19 | 190 | 30 | 60 | 60 | 100 | 2.2 | 16 |
| Film 9 | cellulose acetate | 2.41 | 23.1 | B1 | 12 | 170 | 60 | 80 | 210 | 220 | 1.5 | 16 |
| Film 10 | cellulose acetate | 2.41 | 23.1 | B1 | 15 | 190 | 45 | 58 | 75 | 90 | 1.7 | 16 |
| Film 11 | cellulose acetate | 2.41 | 23.1 | B1 | 19 | 190 | 60 | 55 | 100 | 90 | 1.4 | 16 |
| Film 12 | cellulose acetate | 2.41 | 23.1 | B1 | 19 | 185 | TD 40/MD −17 | 50 | 120 | 100 | 1.3 | 16 |
| Film 13 | cellulose acetate | 2.41 | 23.1 | B1 | 19 | 185 | TD 60/MD −25 | 50 | 140 | 75 | 1.0 | 16 |
| Film 14 | cyclic olefin | — | 18.7 | — | — | 140 | TD 60/MD −25 | 60 | 125 | 70 | 1.1 | 3 |

### 2. Formation of Layer C

### (1) Formation of Layer C Containing Fumarate Resin as the Main Ingredient

### (1)-1 Production of Fumarate Resin

48 g of hydroxypropylmethyl cellulose (Shin-etsu Chemical's trade name, Metolose 60SH-50), 15601 g of distilled water, 8161 g of diisopropyl fumarate, 240 g of 3-ethyl-3-oxetanylmethyl acrylate and 45 g of a polymerization initiator, t-butyl peroxypivalate were put into a 30-liter autoclave equipped with a stirrer, a condenser tube, a nitrogen-introducing duct and a thermometer, bubbled with nitrogen for 1 hour, and then kept heated at 49° C. with stirring at 200 rpm for 24 hours for radical suspension polymerization. After cooled to room temperature, the suspension containing the formed polymer particles was separated by centrifugation. The obtained polymer particles were washed twice with distilled water and twice with methanol, and dried under reduced pressure at 80° C. (yield: 80%).

### (1)-2 Formation of Layer C

The fumarate resin obtained in Synthesis Example 1 was dissolved in a mixed solvent shown in Table 5 below to prepare a 20% solution, and further, a surfactant, “AF-1000” (by Kyoeisha Chemical, SP value 10.0, Mw 2000, acid value 110 mg-KOH/g-resin) or “Floren G-700” (by Kyoeisha Chemical, SP value 11.3, Mw 10000, acid value 60 mg-KOH/g-resin) was added thereto in an amount of 1 part by weight relative to 100 parts by weight of the fumarate resin. The resulting mixture was applied onto the surface of the film prepared as above, and dried at 80° C. and at 130° C. for 4 minutes each to form a layer C thereon, thereby producing a laminate film.

### (2) Formation of Layer C Containing Styrene-Maleic Anhydride Copolymer as the Main Ingredient

A styrene-maleic anhydride copolymer D332 was bought from NOVA Chemicals, and dissolved in a mixed solvent shown in Table below to prepare a 20% solution, and further, a surfactant “AF-1000” (by Kyoeisha Chemical, SP value 10.0, Mw 2000, acid value 110 mg-KOH/g-resin) shown in the following Table was added thereto in an amount of 1 part by weight relative to 100 parts by weight of the styrene-maleic anhydride copolymer. The resulting mixture was applied onto the surface of the film prepared as above, and dried at 90° C. and at 100° C. for 4 minutes each to form a layer C thereon, thereby producing a laminate film.

### (3) Formation of Layer C of Homeotropic Liquid Crystal Layer

### (3)-1 Formation of Alignment Film

The surface of the film for B layer produced in the above was saponified. A commercially-available composition for vertical alignment film (JALS-204R, by JSR) was diluted with methyl ethyl ketone in a ratio of 1/1, and using a wire bar coater, this was applied onto the saponified surface of the film in an amount of 2.4 ml/m². Immediately, this was dried with hot air at 120° C. for 120 seconds to form a vertical alignment film.

### (3)-2 Formation of Homeotropic Liquid Crystal Layer

A solution prepared by dissolving 1.8 g of a rod-shaped liquid crystal compound mentioned below, 0.06 g of a photopolymerization initiator (Irgacure 907, by Ciba-Geigy), 0.02 g of a sensitizer (Kayacure DETX, by Nippon Kayaku) and 0.002 g of an air interface-side vertically-aligning agent mentioned below in 9.2 g of cyclohexane/cyclopentanone (=65/35, % by mass) was applied onto the alignment film, using a #2 wire bar. This was attached to a metal frame, and heated in a thermostat bath at 100° C. for 2 minutes to thereby align the rod-shaped liquid crystal compound. Next, using a 120 W/cm high-pressure mercury lamp, this was irradiated with UV at 100° C. for 30 seconds to thereby crosslink the rod-shaped liquid crystal compound. Subsequently, this was cooled to room temperature.

### Rod-Shaped Liquid Crystal Compound

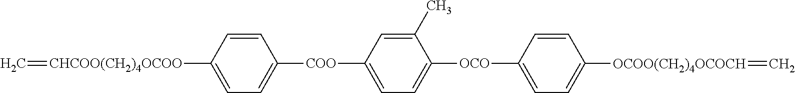

### Air Interface-Side Vertically-Aligning Agent

### Exemplary Compound (II-4) Described in JP-A 2004-139015

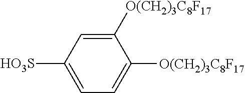

In the manner as above, a laminate film having a layer C of a homeotropic liquid crystal layer on the film of layer B was produced.

### (3) Layer Forming Conditions and Characteristics of Layer

The layer forming conditions and the characteristics of the formed layer are shown in Table 5 below.

TABLE 5

| | Main Ingredient | | Additive | | Solvent | | Characteristics | | |
|---|---|---|---|---|---|---|---|---|---|
| No. of | | SP | | Amount | | Composition | Thickness | Re | Rth |
| Layer C | Material (*1) | Value | Additive (*2) | Added | Type of Solvent | % by mass | μm | nm | nm |
| Layer 1 | F | 19.4 | C1 | 2 | TOLUENE/MEK | 50/50 | 15 | 2 | −110 |
| Layer 2 | F | 19.4 | C1 | 2 | TOLUENE/MEK | 50/50 | 15 | 1 | −110 |
| Layer 3 | F | 19.4 | C2 | 2 | MIBK/MEK | 35/65 | 15 | 2 | −140 |
| Layer 4 | F | 19.4 | C1 | 2 | MIBK/MEK | 35/65 | 15 | 3 | −112 |
| Layer 5 | F | 19.4 | C1 | 2 | MIBK/MEK | 35/65 | 15 | 2 | −108 |
| Layer 6 | F | 19.4 | C1 | 2 | TOLUENE/MEK | 50/50 | 18 | 2 | −116 |
| Layer 7 | S | 20.3 | C1 | 2 | MIBK/MEK | 35/65 | 15 | 2 | −65 |
| Layer 8 | S | 20.3 | C1 | 2 | MIBK/MEK | 35/65 | 10 | 0 | −48 |
| Layer 9 | S | 20.3 | C1 | 2 | MIBK/MEK | 35/65 | 15 | 1 | −85 |
| Layer 10 | F | 19.4 | C1 | 2 | MIBK/MEK | 35/65 | 15 | 2 | −112 |
| Layer 11 | F | 19.4 | C1 | 2 | MIBK/MEK | 35/65 | 15 | 2 | −113 |
| Layer 12 | F | 19.4 | C1 | 2 | MIBK/MEK | 35/65 | 15 | 2 | −112 |
| Layer 13 | F | 19.4 | C1 | 2 | MIBK/MEK | 35/65 | 15 | 1 | −112 |
| Layer 14 | F | 19.4 | C1 | 2 | MIBK/MEK | 35/65 | 15 | 2 | −111 |
| Layer 15 | F | 19.4 | C1 | 2 | MIBK/MEK | 35/65 | 8 | 1 | −75 |
| Layer 16 | L | 18.7 | NONE | 0 | CYCLOHEXANE/ | 65/35 | 1 | 1 | −103 |
| | | | | | CYCLOPENTANONE | | | | |

(*1) F: Fumarate resin produced in the above. S: Styrene-maleic anhydride copolymer D332. L: Polymer of polymerizing rod-like liquid crystal.
(*2) C1: Kyoeisha Chemical's Floren AF1000 C2: Kyoeisha Chemical's Floren G-700

### 3. Production of Polarizer

The laminate film produced in the above was stuck to a polyvinyl alcohol polarizing element with an adhesive put therebetween, and FUJIFILM's Fujitac T60 was to the opposite surface of the polarizing element in the same manner, thereby producing a polarizer. The laminate film was stuck to the polarizing element in such a manner that the surface of the layer B could face the surface of the polarizing element, as shown in FIG. 1.

In mounting the polarizer on a liquid crystal display device, the laminate film was arranged between the liquid crystal cell and the polarizing element in every case.

Of the above-mentioned laminate films, the adhesiveness to the polarizing element of the laminate film having the polycarbonate film 6 as the layer B was poorer than that of the laminate film having a cellulose acylate film as the layer B; and when blanked, delamination occurred in the former laminate film between the layer C and the layer B at the edge thereof.

The polarizer produced in the above was used as the panel-side polarizer as described below. As the backlight-side polarizer to be combined with the panel-side polarizer, used was a polarizer produced by sticking Z-TAC (by FUJIFILM) to one surface of a polarizing element and sticking FUJIFILM's Fujitac T60 to the other surface thereof. The polarizer was mounted on a liquid crystal display device in such a manner that the Z-TAC film could be arranged between the liquid crystal cell and the polarizing element.

### 3. Production and Evaluation of Liquid Crystal Display Device

### (1) Production of Liquid Crystal Display Device

The polarizer having the laminate film produced in the above was mounted on the panel side of an IPS-mode liquid crystal cell (in which the value of d·Δn of the liquid crystal layer was 300 nm), and the polarizer having the Z-TAC film produced in the above was mounted on the backlight side thereof, thereby producing an IPS-mode liquid crystal display device having the same configuration as in FIG. 3.

### (2) Evaluation of Liquid Crystal Display Device

### (Front Contrast Evaluation)

A backlight was set in the IPS-mode liquid crystal display device produced in the above, and using a contrast meter (EZ-Contrast XL88, by ELDIM), the brightness at the time of black level of display and at the time of white level of display of the device was measured. From the found data, the front contrast ratio (CR) was calculated and evaluated according to the following criteria.

A: 1400 or more.

### B: 1300≦CR≦1400.

### C: 1200≦CR≦1300.

D: less than 1200.

### (Display Unevenness Evaluation)

A backlight was set in the IPS-mode liquid crystal display device produced in the above, and the panel condition was visually checked and evaluated according to the following criteria.

A: No unevenness seen visually at all.
B: Slight unevenness seen visually.
C: Unevenness seen visually, but no problem.
D: Definite unevenness seen visually, and problematic.

### (Color Shift Evaluation)

A backlight was set in the IPS-mode liquid crystal display device produced in the above, and using a contrast meter (EZ-Contrast XL88, by ELDIM), the panel of the device was checked at the time of black level of display in the polar angle direction of 60 degrees relative to the front. Data of the maximum ΔE at a direction angle of from 0 to 90 degrees (1st quadrant), from 90 to 180 degrees (2nd quadrant), from 180 to 270 degrees (3rd quadrant) and from 270 to 360 degrees (4th quadrant) were averaged, and the resulting value was defined as the color shift of the device. The device was evaluated according to the following criteria.

A: Little color shift detected.
B: Some color shift detected but no problem in practical use.
C: Color shift detected and problematic in practical use.

### (Viewing Angle CR Evaluation)

A backlight was set in the IPS-mode liquid crystal display device produced in the above, and using a contrast meter (EZ-Contrast XL88, by ELDIM), the brightness at the time of black level of display and at the time of white level of display of the device was measured in a dark room. The mean value of the minimum values in each quadrant in the polar angle direction of 60 degrees was defined as the viewing angle contrast ratio (viewing angle CR). From the thus-calculated values, the device was evaluated according to the following criteria.

A: The viewing angle CR was 100 or more, and there was no problem in practical use.
B: The viewing angle CR was from 70 to less than 100, and there was almost no problem in practical use.
C: The viewing angle CR was from 50 to less than 70, and was slightly problematic in practical use.
D: The viewing angle CR was less than 50, and was problematic in practical use.

The evaluation results are shown below, along with the characteristics of the layer B and the layer C.

TABLE 6

| | Layer B | | | | | | | | |
|---|---|---|---|---|---|---|---|---|---|
| Example/ | | main ingredient | | | characteristics | | | | |
| Comparative | | | degree of Ac | | thickness | Re | Rth | | photoelastic |
| Example | Film No. | material | substitution | SP value | (m | nm | nm | Nz | coefficient |
| Example 1 | Film 1 | cellulose | 2.10 | 24.2 | 55 | 150 | 150 | 1.5 | 22 |
| | | acetate | | | | | | | |
| Example 2 | Film 2 | cellulose | 2.41 | 23.1 | 55 | 110 | 105 | 1.5 | 17 |
| | | acetate | | | | | | | |
| Example 3 | Film 3 | cellulose | 2.71 | 22.2 | 55 | 72 | 75 | 1.5 | 16 |
| | | acetate | | | | | | | |
| Example 4 | Film 4 | cellulose | 2.79 | 22.0 | 55 | 80 | 80 | 1.5 | 18 |
| | | acetate | | | | | | | |
| Comparative | Film 5 | cellulose | 2.86 | 21.9 | 55 | 10 | 30 | 3.5 | 15 |
| Example 1 | | acetate | | | | | | | |
| Comparative | Film 6 | polycarbonate | — | 21.7 | 75 | 125 | 70 | 1.1 | 95 |
| Example 2 | | | | | | | | | |
| Example 5 | Film 7 | cellulose | 2.41 | 23.1 | 55 | 100 | 90 | 1.4 | 16 |
| | | acetate | | | | | | | |
| Comparative | Film 7 | cellulose | 2.41 | 23.1 | 55 | 100 | 90 | 1.4 | 16 |
| Example 3 | | acetate | | | | | | | |
| Example 6 | Film 7 | cellulose | 2.41 | 23.1 | 55 | 100 | 90 | 1.4 | 16 |
| | | acetate | | | | | | | |
| Comparative | Film 8 | cellulose | 2.41 | 23.1 | 60 | 60 | 100 | 2.2 | 16 |
| Example 4 | | acetate | | | | | | | |
| Comparative | Film 9 | cellulose | 2.41 | 23.1 | 80 | 210 | 220 | 1.5 | 16 |
| Example 5 | | acetate | | | | | | | |

| | Layer C | | | | | | Evaluation | | | |
|---|---|---|---|---|---|---|---|---|---|---|
| Example/ | | characteristics | main ingredient | | Laminate Film | | | | | viewing |
| Comparative | Layer | Re/Rth | | SP | | thickness | front | | color | angle |
| Example | No. | nm | material | value | ΔSP | (m | CR | unevenness | shift | CR |
| Example 1 | layer 1 | 2/−110 | F | 19.4 | 4.82 | 70 | B | B | B | B |
| Example 2 | layer 2 | 1/−110 | F | 19.4 | 3.72 | 70 | A | B | A | A |
| Example 3 | layer 3 | 2/−140 | F | 19.4 | 2.87 | 70 | B | B | B | B |
| Example 4 | layer 4 | 3/−112 | F | 19.4 | 2.65 | 70 | C | B | C | C |
| Comparative | layer 5 | 2/−108 | F | 19.4 | 2.52 | 70 | D | B | D | D |
| Example 1 | | | | | | | | | | |
| Comparative | layer 6 | 2/−116 | F | 19.4 | 2.36 | 93 | C | D | B | B |
| Example 2 | | | | | | | | | | |
| Example 5 | layer 7 | 2/−65 | S | 20.3 | 2.77 | 70 | B | B | B | B |
| Comparative | layer 8 | 0/−48 | S | 20.3 | 2.77 | 65 | C | B | D | D |
| Example 3 | | | | | | | | | | |
| Example 6 | layer 9 | 1/−85 | S | 20.3 | 2.62 | 70 | A | B | A | A |
| Comparative | layer 10 | 2/−112 | F | 19.4 | 3.72 | 75 | C | B | D | D |
| Example 4 | | | | | | | | | | |
| Comparative | layer 11 | 2/−113 | F | 19.4 | 3.72 | 95 | C | B | D | D |
| Example 5 | | | | | | | | | | |

TABLE 7

| | Layer B | | | | | | | | |
|---|---|---|---|---|---|---|---|---|---|
| Example/ | | main ingredient | | | characteristics | | | | |
| Comparative | | | degree of Ac | | thickness | Re | Rth | | photoelastic |
| Example | Film No. | material | substitution | SP value | (m | nm | nm | Nz | coefficient |
| Example 7 | Film 10 | cellulose | 2.41 | 23.1 | 58 | 75 | 90 | 1.7 | 16 |
| | | acetate | | | | | | | |
| Example 8 | Film 11 | cellulose | 2.41 | 23.1 | 55 | 100 | 90 | 1.4 | 16 |
| | | acetate | | | | | | | |
| Example 9 | Film 12 | cellulose | 2.41 | 23.1 | 50 | 120 | 100 | 1.3 | 16 |
| | | acetate | | | | | | | |
| Example 10 | Film 13 | cellulose | 2.41 | 23.1 | 50 | 140 | 75 | 1.0 | 16 |
| | | acetate | | | | | | | |
| Example 11 | Film 14 | cyclic olefin | — | 18.7 | 60 | 125 | 70 | 1.1 | 3 |

| | Layer C | | | | | | Evaluation | | | |
|---|---|---|---|---|---|---|---|---|---|---|
| Example/ | | characteristics | main ingredient | | Laminate Film | | | | | viewing |
| Comparative | Layer | Re/Rth | | SP | | thickness | front | | color | angle |
| Example | No. | nm | material | value | ΔSP | (m | CR | unevenness | shift | CR |
| Example 7 | layer 12 | 2/−112 | F | 19.4 | 3.72 | 73 | B | B | B | B |
| Example 8 | layer 13 | 1/−112 | F | 19.4 | 3.72 | 70 | A | B | A | A |
| Example 9 | layer 14 | 2/−111 | F | 19.4 | 3.72 | 65 | A | B | A | A |
| Example 10 | layer 15 | 1/−75 | F | 19.4 | 3.72 | 58 | A | B | A | A |
| Example 11 | layer 16 | 1/−103 | L | 22.3 | 3.6 | 62 | B | B | B | B |

From the results shown in the above Tables, it is understood that, when a laminate film, which comprises the layer B satisfying the above formulae (Ib) and (IIb) and the layer C satisfying the above formulae (Ic) and (IIc) and in which the absolute value of the difference in the SP value of the main ingredient between the layer B and the layer C, ((SP (is at least 2.6, is used in a horizontal alignment mode liquid crystal display device, then the viewing angle characteristics in oblique directions of the device can be improved with neither causing reduction in the front contrast ratio nor causing display unevenness.

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2012/071370, filed Aug. 17, 2012; and Japanese Patent Application No. 2011-186772 filed on Aug. 30, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims.

What is claimed is:

1. An optical laminate film that comprises a layer B satisfying the following three formulae (Ib) to (IIIb):
1.0≦Nz≦3.0 (Ib):
70 nm≦Re(550) (IIb):
0 nm≦Rth(550)≦200 nm, (IIIb):
and a layer C satisfying the following two formulae (Ic) and (IIc):
Re(550)≦10 nm (Ic):
−200 nm≦Rth(550)≦−50 nm, (IIc):
wherein the layer B and the layer C are adjacent to each other, the absolute value of the difference in SP, as calculated on the basis of the Hoy method, between the main ingredient of the layer B and the main ingredient of the layer C, |ΔSP| is from 2.6 to 10.0.

2. The optical laminate film according to claim 1, wherein the main ingredient of the layer B is a cellulose acetate having a degree of substitution of from 2.0 to 2.8.

3. The optical laminate film according to claim 1, wherein the main ingredient of the layer B is a cellulose acetate having a degree of substitution of from 2.2 to 2.5.

4. The optical laminate film according to claim 1, wherein the photoelastic coefficient of the layer B is at most 40.

5. The optical laminate film according to claim 1, wherein the layer C is a layer comprising a polymer organic compound as the main ingredient thereof.

6. The optical laminate film according to claim 1, wherein the layer C is a layer formed by fixing the homeotropic alignment of a composition that comprises rod-shaped liquid crystal molecules as the main ingredient thereof.

7. The optical laminate film according to claim 1, wherein at least one of the layer C and the layer B is a layer formed by coating.

8. The optical laminate film according to claim 1, having a total thickness of at most 80 μm.

9. A polarizer comprising a polarizing element and a optical laminate film, wherein the optical laminate film comprises a layer B satisfying the following three formulae (Ib) to (IIIb):
1.0≦Nz≦3.0 (Ib):
70 nm≦Re(550) (IIb):
0 nm≦Rth(550)≦200 nm, (IIIb):
and a layer C satisfying the following two formulae (Ic) and (IIc):
Re(550)≦10 nm (Ic):
−200 nm≦Rth(550)≦−50 nm, (IIc):
wherein the layer B and the layer C are adjacent to each other, the absolute value of the difference in SP, as calculated on the basis of the Hoy method, between the main ingredient of the layer B and the main ingredient of the layer C, |ΔSP| is from 2.6 to 10.0.

10. A horizontal alignment mode liquid crystal display device having a optical laminate film comprising a layer B satisfying the following three formulae (Ib) to (IIIb):
1.0≦Nz≦3.0 (Ib):
70 nm≦Re(550) (IIb):
0 nm≦Rth(550)≦200 nm, (IIIb):
and a layer C satisfying the following two formulae (Ic) and (IIc):
Re(550)≦10 nm (Ic):
−200 nm≦Rth(550)≦−50 nm, (IIc):
wherein the layer B and the layer C are adjacent to each other, the absolute value of the difference in SP, as calculated on the basis of the Hoy method, between the main ingredient of the layer B and the main ingredient of the layer C, |ΔSP| is from 2.6 to 10.0.
